(19) United States
(12) Patent Application Publication
(10) Pub. No.: US 2026/0202680 A1
(43) Pub. Date: Jul. 16, 2026

(54) CAMERA ACTUATOR AND CAMERA MODULE COMPRISING SAME

(71) Applicant: LG INNOTEK CO., LTD., Seoul (KR)

(72) Inventors: Sung Guk LEE, Seoul (KR); Jeong Gi YOU, Seoul (KR)

(73) Assignee: LG INNOTEK CO., LTD., Seoul (KR)

(21) Appl. No.: 19/136,992

(22) PCT Filed: Dec. 20, 2023
(86) PCT No.: PCT/KR2023/021056

§ 371 Date: Jun. 9, 2025

(30) Foreign Application Priority Data
Dec. 26, 2022 (KR) 10-2022-0184700

(51) Int. Cl. G02B 27/64; G03B 5/00

(52) U.S. Cl. CPC G02B 27/646; G03B 5/00; G03B 2205/0007; G03B 2205/0069

(57) ABSTRACT

An embodiment of the present invention discloses a camera actuator comprising: a housing; a mover including a holder and an optical member disposed on the holder; a driving unit that moves the mover; and a tilting guide unit disposed between the housing and the mover to guide tilting of the mover, wherein the mover is rotatable in at least one of a first direction and a second direction, the driving unit includes a first magnet and a second magnet disposed below the first magnet, and the holder includes a first holder outer surface and a second holder outer surface that face each other in the second direction, wherein the first magnet is disposed only on one of the first holder outer surface and the second holder outer surface.

### CROSS REFERENCE TO RELATED APPLICATIONS

This application is the National Phase of PCT International Application No. PCT/KR 2023/021056, filed on Dec. 20, 2023, which claims priority under 35 U.S.C. 119(a) to Patent Application No. 10-2022-0184700 filed on Dec. 26, 2022, all filed in the Republic of Korea, respectively, all of which are hereby expressly incorporated by reference into the present application.

### TECHNICAL FIELD

The present invention relates to a camera actuator and a camera module including the same.

### BACKGROUND ART

Cameras are devices for taking pictures or videos by capturing images of subjects and are mounted on mobile devices, drones, vehicles, etc. To improve the quality of an image, a camera module may have an image stabilizer (IS) function for correcting or preventing an image shake caused by the movement of a user, an auto focusing (AF) function for aligning a focal length of a lens by automatically adjusting an interval between an image sensor and the lens, and a zooming function for capturing an image of a remote subject by increasing or decreasing the magnification of the image of the remote subject through a zoom lens.

However, to perform a hand-shake prevention function in the camera module, there is a need for a collision absorption structure for suppressing damage to a mover or the like due to a collision.

Furthermore, there is an increasing demand for improving the reliability and driving efficiency of the camera module and reducing weight.

### DETAILED DESCRIPTION OF INVENTION

### Technical Problem

The present invention is directed to providing a camera actuator and a camera device in which efficiency of a driving force required for OIS driving is increased and of which the weights are reduced.

In addition, embodiments of the present invention are directed to providing a camera actuator and a camera device with improved reliability with shock absorption.

In addition, embodiments of the present invention are directed to providing a camera actuator applicable to ultra-slim, ultra-small, and high-resolution cameras.

Objects of embodiments are not limited thereto and may also include objects or effects that may be identified from the configurations or embodiments to be described below.

### Technical Solution

A camera actuator according to an embodiment of the present invention includes a housing, a mover including a holder and an optical member disposed on the holder, a driving unit that moves the mover, and a tilting guide unit disposed between the housing and the mover to guide tilting of the mover, wherein the mover is rotatable in at least one of a first direction and a second direction, the driving unit includes a first magnet and a second magnet disposed below the first magnet, and the holder includes a first holder outer surface and a second holder outer surface that face each other in the second direction, wherein the first magnet is disposed only on one of the first holder outer surface and the second holder outer surface.

The holder may be asymmetrical with respect to a third direction perpendicular to the first direction and the second direction.

The driving unit may include a first coil facing the first magnet and a second coil facing the second magnet, and the first coil may be disposed on only a side portion of the housing which faces one of the first holder outer surface and the second holder outer surface.

The driving unit may include a substrate unit connected to the first coil, and the substrate unit may be disposed on a side portion of the housing which faces one of the first holder outer surface and the second holder outer surface.

The substrate unit may be asymmetrical with respect to the third direction perpendicular to the first direction and the second direction.

The first magnet may be disposed on the second holder outer surface.

The first holder outer surface may overlap a hole of a first housing side portion of the housing, which faces the first holder outer surface, in a third direction.

A first separation distance may be greater than a second separation distance, the first separation distance may be a distance between the first holder outer surface and a first housing side portion of the housing in the second direction, and the second separation distance may be a distance between the second holder outer surface and a second housing side portion of the housing in the second direction.

The optical member may be asymmetrical with respect to a third direction perpendicular to the first direction and the second direction.

A separation distance from the first housing side portion of the housing in the second direction may differ from a separation distance from the second housing side portion of the housing in the second direction in the optical member.

The optical member may change an optical path from the first direction to the third direction perpendicular to the first direction and the second direction.

The camera actuator may further include a first magnet disposed in the housing, and a second magnet disposed to face the first magnet, wherein the tilting guide unit may be pressed by the mover by a repulsive force between the first magnet and the second magnet.

The housing may include a first member disposed on one side, the mover may include a second member passing through the first member, and the tilting guide unit may be disposed between the first member and the mover.

The first member may include a second groove located in an outer surface thereof, the second member may include a first groove facing the second groove, the first magnet may be disposed in the second groove, and the second magnet may be disposed in the first groove.

The second magnet, the first magnet, and the tilting guide unit may be disposed sequentially in the second direction and may include a shock absorption member disposed below the second member.

### Advantageous Effects

According to embodiments of the present invention, it is possible to implement a camera actuator and a camera device in which efficiency of a driving force required for OIS driving is increased and of which the weights are reduced.

According to the present disclosure, it is possible to implement a camera actuator applicable to ultra-slim, ultra-small, and high-resolution cameras.

Various and beneficial advantages and effects of the present invention are not limited to the above-described contents and will be more readily understood during a process of describing specific embodiments of the present invention.

### DESCRIPTION OF DRAWINGS

FIG. 1 is a perspective view of a camera module according to an embodiment.

FIG. 2 is an exploded perspective view of the camera module according to the embodiment.

FIG. 3 is a view along line AA′ in FIG. 1.

FIG. 4 is a perspective view of a first camera actuator according to the embodiment.

FIG. 5 is an exploded perspective view of the first camera actuator according to the embodiment.

FIG. 6A is a perspective view of a first housing of the first camera actuator according to the embodiment.

FIG. 6B is a perspective view in a different direction from FIG. 6A.

FIG. 6C is a front view of the first housing of the first camera actuator according to the embodiment.

FIG. 6D is a rear view of the first housing of the first camera actuator according to the embodiment;

FIG. 6E is a top view of the first housing of the first camera actuator according to the embodiment;

FIG. 7 is a perspective view of an optical member of the first camera actuator according to the embodiment.

FIG. 8A is a perspective view of a holder of the first camera actuator according to the embodiment.

FIG. 8B is a perspective view in a different direction from FIG. 8A.

FIG. 8C is a bottom view of the holder of the first camera actuator according to the embodiment.

FIG. 8D is a front view of the holder of the first camera actuator according to the embodiment.

FIG. 8E is a rear view of a second member of the first camera actuator according to the embodiment.

FIG. 8F is a bottom view of the second member of the first camera actuator according to the embodiment.

FIG. 9A is a perspective view of a tilting guide unit of the first camera actuator according to the embodiment.

FIG. 9B is a perspective view in a different direction from FIG. 9A.

FIG. 9C is a view along line FF′ in FIG. 9A.

FIG. 10 is a view illustrating a first driving unit of the first camera actuator according to the embodiment.

FIG. 11A is a perspective view of the first camera actuator according to the embodiment.

FIG. 11B is a view along line PP′ in FIG. 11A.

FIG. 11C is a view along line QQ′ in FIG. 11A.

FIG. 11D is a rear view of the first camera actuator according to the embodiment.

FIG. 11E is a top view of the first camera actuator according to the embodiment.

FIG. 12A is a perspective view of the first camera actuator according to the embodiment.

FIG. 12B is a view along line SS′ in FIG. 12A.

FIG. 12C is an exemplary view of movement of the first camera actuator illustrated in FIG. 12B.

FIG. 13A is a view along line RR′ in FIG. 12A.

FIG. 13B is an exemplary view of movement of the first camera actuator illustrated in FIG. 13A.

FIG. 13C is a view illustrating a collision of a housing wall with respect to the movement of the first camera actuator illustrated in FIG. 13A.

FIG. 14 is a cross-sectional view of the first camera actuator according to a modified example.

FIG. 15 is a cross-sectional view of a first camera actuator according to another embodiment.

FIG. 16 is a cross-sectional view of a first camera actuator according to still another embodiment.

FIG. 17 is a cross-sectional view of a first camera actuator according to yet another embodiment.

FIG. 18 shows a perspective view and a cross-sectional view of the first camera actuator according to the embodiment.

FIG. 19 is a perspective view of a second camera actuator according to the embodiment.

FIG. 20 is a view along line DD′ in FIG. 19.

FIG. 21 is a schematic view illustrating a circuit board according to the embodiment.

FIG. 22 is a perspective view of a mobile terminal to which the camera module according to the embodiment is applied.

FIG. 23 is a perspective view of a vehicle to which the camera module according to the embodiment is applied.

### MODES OF THE INVENTION

Since embodiments of the present invention may have various changes and various embodiments, specific embodiments are illustrated and described in the accompanying drawings. However, it should be understood that it is not intended to limit specific embodiments, and it should be understood to include all modifications, equivalents, and substitutes included in the spirit and scope of the present invention.

Terms including ordinal numbers such as second or first may be used to describe various components, but the components are not limited by the terms. The terms are used only for the purpose of distinguishing one component from another. For example, a second component may be referred to as a first component, and similarly, the first component may also be referred to as the second component without departing from the scope of the present invention. The term “and/or” includes a combination of a plurality of related listed items or any of the plurality of related listed items.

When a first component is described as being “connected” or “coupled” to a second component, it should be understood that the first component may be directly connected or coupled to the second component or a third component may be present therebetween. On the other hand, when a certain component is described as being “directly connected” or “directly coupled” to another component, it should be understood that still another component is not present therebetween.

Terms used in the present application are only used to describe specific embodiments and are not intended to limit the present invention. The singular includes the plural unless the context clearly dictates otherwise. In the application, it should be understood that terms “include” and “have” are intended to specify that a feature, a number, a step, an operation, a component, a part, or a combination thereof described in the specification is present, but do not preclude the possibility of the presence or addition of one or more other features, numbers, steps, operations, components, parts, or combinations thereof.

Unless defined otherwise, all terms used herein, including technical or scientific terms, have the same meaning as commonly understood by those skilled in the art to which the present invention pertains. Terms such as those defined in a commonly used dictionary should be construed as having a meaning consistent with the meaning in the context of the related art and should not be construed in an ideal or excessively formal meaning unless explicitly defined in the application.

Hereinafter, embodiments will be described in detail with reference to the accompanying drawings, and the same or corresponding components are denoted by the same reference numeral regardless of the reference numerals, and overlapping descriptions thereof will be omitted.

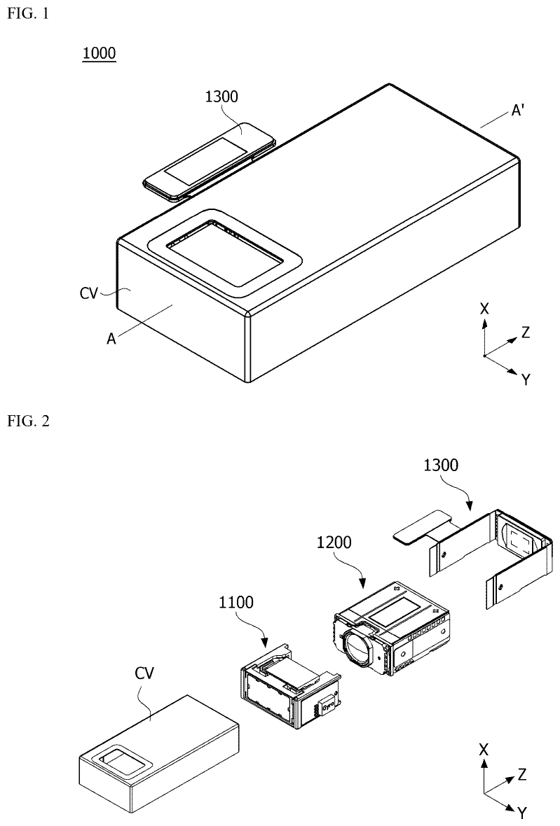

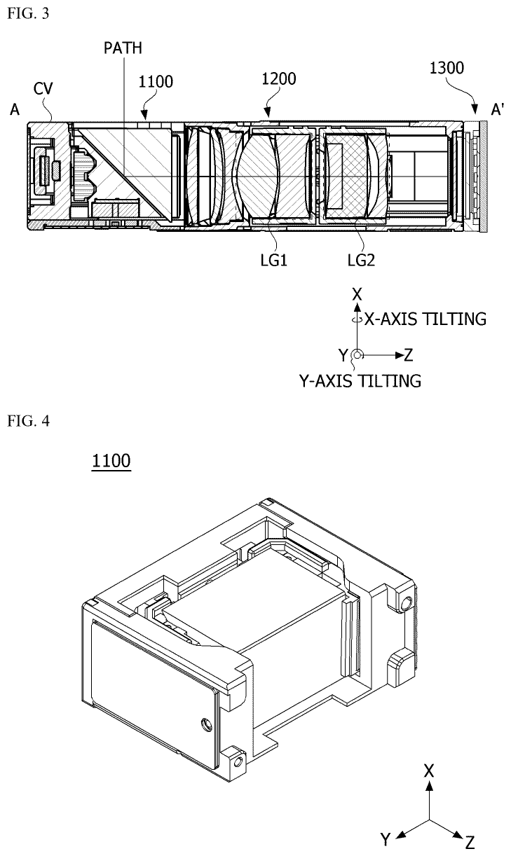

FIG. 1 is a perspective view of a camera module according to an embodiment, FIG. 2 is an exploded perspective view of the camera module according to the embodiment, and FIG. 3 is a view along line AA′ in FIG. 1.

Referring to FIGS. 1 and 2, a camera module 1000 according to the embodiment may include a cover CV, a first camera actuator 1100, a second camera actuator 1200, and a circuit board 1300. Here, the first camera actuator 1100 may be used interchangeably with “first actuator,” and the second camera actuator 1200 may be used interchangeably with “second actuator.”

The cover CV may cover the first camera actuator 1100 and the second camera actuator 1200. It is possible to increase a coupling force between the first camera actuator 1100 and the second camera actuator 1200 by the cover CV.

Furthermore, the cover CV may be formed of a material that blocks electromagnetic waves. Accordingly, it is possible to easily protect the first camera actuator 1100 and the second camera actuator 1200 in the cover CV.

In addition, the first camera actuator 1100 may be an optical image stabilizer (OIS) actuator. For example, the first camera actuator 1100 may move an optical member in a direction perpendicular to the optical axis (axis of incident light).

The first camera actuator 1100 may include a fixed focal length lens disposed in a predetermined barrel (not illustrated). The fixed focal length lens may be referred to as “single focal length lens” or “single lens.”

The first camera actuator 1100 may change an optical path. In an embodiment, the first camera actuator 1100 may vertically change the optical path through an internal optical member (e.g., a prism or a mirror). For example, the optical member may change light from a first direction (an X-axis direction) to a third direction (a Z-axis direction). With this configuration, even when a thickness of a mobile terminal is decreased, a lens with a focal length that is greater than the thickness of the mobile terminal is disposed in the mobile terminal through a change in the optical path so that magnification and auto focusing (AF), zooming, and OIS functions may be performed.

However, the embodiments of the present invention are not limited thereto, and the first camera actuator 1100 may change the optical path vertically or at a predetermined angle multiple times.

The second camera actuator 1200 may be disposed behind the first camera actuator 1100. The second camera actuator 1200 may be coupled to the first camera actuator 1100. In addition, mutual coupling may be performed by various methods.

In addition, the second camera actuator 1200 may be a zoom actuator or an AF actuator. For example, the second camera actuator 1200 may support one lens or a plurality of lenses LG1 and LG2 and perform an AF function or a zooming function by moving the lenses according to a predetermined control signal of a control unit.

In addition, one lens or the plurality of lens LG1 and LG2 may independently or separately move in an optical axis direction.

The circuit board 1300 may be disposed behind the second camera actuator 1200. The circuit board 1300 may be electrically connected to the second camera actuator 1200 and the first camera actuator 1100. In addition, the circuit board 1300 may be provided as a plurality of circuit boards.

A camera module according to the embodiment may be formed of one camera module or a plurality of camera modules. For example, the plurality of camera modules may include a first camera module and a second camera module.

In addition, a single camera module may include one actuator or a plurality of actuators. For example, the single camera module may include the first camera actuator 1100 and the second camera actuator 1200.

In addition, the camera module may include an actuator (not illustrated) disposed in a predetermined housing (not illustrated) and capable of driving a lens unit. The actuator may be a voice coil motor, a micro actuator, a silicone actuator, etc. and applied in various methods, such as an electrostatic method, a thermal method, a bimorph method, an electrostatic force method, etc., but is not limited thereto. In addition, in the present specification, the camera actuator may be referred to as “actuator” or the like. In addition, the camera module formed of the plurality of camera modules may be mounted in various electronic devices, such as a mobile terminal. Furthermore, the actuator may be a device for moving or tilting the lens or the optical member. However, hereinafter, the actuator will be described as including the lens or the optical member. Furthermore, the actuator may be referred to as “lens transfer device,” “lens moving device,” “optical member transfer device,” “optical member moving device,” etc.

Referring to FIG. 3, the camera module according to the embodiment may include the first camera actuator 1100 for performing the OIS function and the second camera actuator 1200 for performing the zooming function and the AF function.

Light may enter the camera module or the first camera actuator through an opening region located in an upper surface of the first camera actuator 1100. That is, the light may enter the first camera actuator 1100 in an optical axis direction (e.g., an X-axis direction, based on incident light), and the optical path may be changed in a vertical direction (e.g., a Z-axis direction) through the optical member. In addition, the light may pass through the second camera actuator 1200 and may be incident on an image sensor IS located at one end of the second camera actuator 1200 (PATH). In the present specification, the Z-axis direction or a third direction will be described as the optical axis direction below.

In the present specification, a lower surface refers to one side in a first direction. In addition, the first direction is the X-axis direction in the drawings and may be used interchangeably with a second axis direction. A second direction is a Y-axis direction in the drawings and may be used interchangeably with a first axis direction. The second direction is a direction perpendicular to the first direction. In addition, the third direction is the Z-axis direction in the drawings and may be used interchangeably with a third axis direction. In addition, the third direction is a direction perpendicular to both the first direction and the second direction. Here, the third direction (the Z-axis direction) corresponds to the optical axis direction, and the first direction (the X-axis direction) and the second direction (the Y-axis direction) are directions perpendicular to the optical axis. In addition, hereinafter, the optical axis direction in the description of the first camera actuator and the second camera actuator is a third direction (the Z-axis direction), and based on this, the following description will be given.

In addition, in the present specification, an inside may be a direction from the cover CV to the first camera actuator, and an outside may be a direction opposite to the inside. For example, the first camera actuator and the second camera actuator may be located inside the cover CV, and the cover CV may be located outside the first camera actuator or the second camera actuator.

The camera module according to the embodiment may resolve the spatial limitations of the first camera actuator and the second camera actuator by changing the optical path. The camera module according to the embodiment may extend the optical path while minimizing the thickness of the camera module in response to the change in the optical path. Furthermore, it should be understood that the second camera actuator may provide a high range of magnification by controlling a focus in the extended optical path.

In addition, the camera module according to the embodiment can implement an OIS by controlling the optical path through the first camera actuator, thereby minimizing the occurrence of a decentering or tilting phenomenon and providing the best optical characteristics.

Furthermore, the second camera actuator 1200 may include an optical system and a lens driving unit. For example, at least one of a first lens assembly, a second lens assembly, and a third lens assembly may be disposed in the second camera actuator 1200.

In addition, the second camera actuator 1200 may include a coil and a magnet and perform a high-magnification zooming function and the AF function.

For example, although the first lens assembly and the second lens assembly may be moving lenses that move through the coil, the magnet, and a guide pin and the third lens assembly may be a fixed lens, the embodiments of the present invention are not limited thereto. For example, the third lens assembly may perform a function of a focator by which light forms an image at a specific location and may be in a state of having a big change in magnification due to a big change in distance or phase distance to a subject according to the movement of the first lens assembly. In addition, the first lens assembly, which is a variator, may play an important role in changing the focal length or magnification of the optical system. Meanwhile, imaging points of an image formed by the first lens assembly, which is the variator, may be slightly different depending on a location thereof. Accordingly, the second lens assembly may perform a location compensation function for the image formed by the variator. For example, the second lens assembly may perform a function of a compensator for accurately forming an image at an actual location of the image sensor using the imaging points of the image formed by the first lens assembly which is the variator.

In addition, the first lens assembly and the second lens assembly may be driven by an electromagnetic force generated by interaction between the coil and the magnet. The above description may be applied to a lens assembly to be described below. In addition, the first lens assembly and the second lens assembly may move in the optical axis direction, that is, in the third direction. In addition, the first lens assembly and the second lens assembly may move independently or dependently in the third direction.

Furthermore, the third lens assembly may be located in front of the first lens assembly or behind the second lens assembly. That is, the third lens assembly may be located adjacent to the first camera actuator or adjacent to the image sensor. In addition, the third lens assembly may be fixed.

In the present invention, the first lens assembly and the second lens assembly may move in the optical axis direction. In addition, the third lens assembly may be located in front of the first lens assembly or behind the second lens assembly. In addition, the third lens assembly may not move in the optical axis direction. That is, the third lens assembly may be a fixed part. In addition, the first and second lens assemblies may be moving parts.

Meanwhile, when the OIS actuator and the AF/zoom actuator are disposed according to the embodiment of the present invention, the magnetic field interference with AF/zoom magnets can be prevented when the OIS is driven. Since a magnet of the first camera actuator 1100 is disposed separately from the second camera actuator 1200, it is possible to prevent magnetic interference between the first camera actuator 1100 and the second camera actuator 1200. In the present specification, an OIS may be used interchangeably with terms, such as hand shaking correction, optical image stabilization, optical image correction, shaking correction, etc.

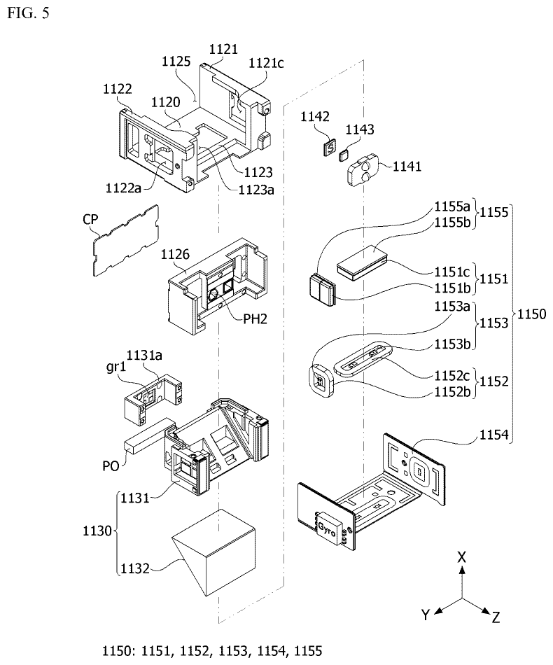

FIG. 4 is an exploded perspective view of the first camera actuator according to the embodiment, and FIG. 5 is an exploded perspective view of the first camera actuator according to the embodiment.

Referring to FIGS. 4 and 5, the first camera actuator 1100 according to the embodiment may include a housing 1120, a mover 1130, a rotating unit 1140, a first driving unit 1150, a first member 1126, and a second member 1131a. Furthermore, the first camera actuator 1100 may further include a plate CP.

The mover 1130 may include a holder 1131 and an optical member 1132 seated on the holder 1131. In addition, the rotating unit 1140 may include a tilting guide unit 1141 and a second magnet 1142 and a first magnet 1143 having the same or different poles to press the tilting guide unit 1141. For example, the first magnet 1143 and the second magnet 1142 may have facing surfaces with the same pole. In addition, the driving unit 1150 includes a driving magnet 1151, a driving coil 1152, a Hall sensor unit 1153, a substrate unit 1154, and a yoke unit 1155.

First, the first camera actuator 1100 may include a shield can (not illustrated). The shield can (not illustrated) may be located at an outermost side of the first camera actuator 1100 and located to surround the rotating unit 1140 and the driving unit 1150, which will be described below.

The shield can (not illustrated) can block or reduce electromagnetic waves generated from the outside. That is, the shield can (not illustrated) can reduce the occurrence of malfunction in the rotating unit 1140 or the driving unit 1150.

The housing 1120 may be located inside the shield can (not illustrated). When there is no shield can, the housing 1120 may be located at the outermost side of the first camera actuator.

In addition, the housing 1120 may be located inside the substrate unit 1154 to be described below. The housing 1120 may be fastened by being inserted into or engaged with the shield can (not illustrated).

The housing 1120 may include a first housing side portion 1121, a second housing side portion 1122, a third housing side portion 1123, and a housing wall 1124. The detailed description thereof will be given below.

The first member 1126 may be disposed in the housing 1120. The second member 1131a may pass through a portion of the first member 1126. The first member 1126 may be disposed in the housing. The first member 1126 may have a structure integrated with the housing 1120. In addition, the first member 1126 may have a structure separated from the housing 1120.

Furthermore, the first camera actuator 1100 may further include the plate CP disposed at an outer side of the first member 1126. The plate CP can prevent foreign substances from flowing into the second member 1131a passing through the first member 1126. Furthermore, the plate CP may be formed of a magnetic material. Accordingly, since the plate CP has magnetism, a magnetic force may not be generated by the first magnet 1143 and the second magnet 1142 having poles for pressing. That is, it is possible to reduce generation of magnetic forces that interfere with the driving (pressing) of the first magnet 1143 and the second magnet 1142.

When the plate CP is the magnet, the plate CP may be referred to as a magnetic member, a magnet, a cover plate, a metal member, a metal plate, etc.

The mover 1130 may include the holder 1131 and the optical member 1132 seated on the holder 1131. The mover 1130 may move or rotate in at least one of the first direction (the X-axis direction) and the second direction (the Y-axis direction). Alternatively, the mover 1130 may rotate with respect to at least one of the first direction (the X-axis direction) and the second direction (the Y-axis direction).

The holder 1131 may be seated in an accommodation unit 1125 of the housing 1120. The holder 1131 may include a first holder outer surface to a fourth holder outer surface corresponding to the first housing side portion 1121, the second housing side portion 1122, the third housing side portion 1123, and the first member 1126, respectively. For example, the first holder outer surface to the fourth holder outer surface may correspond to or face inner surfaces of the first housing side portion 1121, the second housing side portion 1122, the third housing side portion 1123, and the first member 1126, respectively.

In addition, the holder 1131 may include the second member 1131a disposed in a third seating groove. The second member 1131a may be coupled to the holder 1131 after passing through the first member 1126. The second member 1131a and the holder 1131 may be coupled by various bonding members or coupling members. The detailed description thereof will be given below.

The optical member 1132 may be seated on the holder 1131. To this end, the holder 1131 may have a seating surface, and the seating surface may be formed by an accommodation groove. In an embodiment, the optical member 1132 may be composed of a mirror or a prism. Hereinafter, the optical member 1132 is illustrated as being a prism, but may be formed of a plurality of lenses as in the above embodiment. Alternatively, the optical member 1132 may be composed of the plurality of lenses and a prism or a mirror. In addition, the optical member 1132 may include a reflector disposed therein. However, the embodiments of the present invention are not limited thereto.

In addition, the optical member 1132 may reflect light reflected from the outside (e.g., an object) into the camera module. The optical member 1132 may reflect light incident in the first direction (the X-axis direction) in the third direction (the Z-axis direction). That is, the optical member 1132 may change the optical path from the first direction to the third direction. It should be understood that, by changing the optical path, the camera module may provide a high range of magnification by expanding the optical path while minimizing a thickness.

Additionally, the second member 1131a may be coupled to the holder 1131. The second member 1131a may be disposed outside the holder 1131 and inside the housing. In addition, the second member 1131a may be seated in an additional groove located in a region of the fourth holder outer surface of the holder 1131, which excludes the third seating groove. Accordingly, the second member 1131a may be coupled to the holder 1131, and at least a portion of the first member 1126 may be located between the second member 1131a and the holder 1131. For example, the at least a portion of the first member 1126 may be disposed in a space formed between the second member 1131a and the holder 1131. In addition, as described above, the second member 1131a may pass through-holes (a first through-hole and a second through-hole, which will be described below) formed in the first member 1126.

In addition, the second member 1131a may have a structure separated from the holder 1131. With this configuration, the first camera actuator can be easily assembled as will be described below. Alternatively, the second member 1131a may be formed integrally with the holder 1131, but will be described below as having the separated structure.

The rotating unit 1140 includes the tilting guide unit 1141 and the second magnet 1142 and the first magnet 1143 having the same pole to press the tilting guide unit 1141.

The tilting guide unit 1141 may be coupled to the mover 1130 and the housing 1120. Specifically, the tilting guide unit 1141 may be disposed between the holder 1131 and the first member 1126. Accordingly, the tilting guide unit 1141 may be coupled to the mover 1130 of the holder 1131 and the housing 1120.

Specifically, the tilting guide unit 1141 may be located between the first member 1126 and the third seating groove of the holder 1131. For example, at least a portion of the tilting guide unit 1141 may be located in the third seating groove.

The plate CP, the second member 1131a, the first member 1126, the tilting guide unit 1141, and the holder 1131 may be disposed sequentially with respect to the third direction (the Z-axis direction) or the optical axis. In addition, the second magnet 1142 and the first magnet 1143 may be respectively seated in a first groove gr1 formed in the second member 1131a and a second groove gr2 formed in the first member 1126. In the present embodiment, the first groove gr1 and the second groove may be located differently from the first and second grooves described above in other embodiments. However, the first groove gr1 is located in the second member 1131a and moves integrally with the holder and the second member 1131a, and the second groove is located on the first member 1126 corresponding to the first groove gr1 and coupled to the housing 1120. Accordingly, the following description will be given by interchangeably using these terms. Furthermore, the first groove and the second groove may be grooves as described above. Alternatively, the first groove and the second groove may be replaced with the form of a hole.

In addition, the tilting guide unit 1141 may be disposed adjacent to the optical axis. Accordingly, the actuator according to the embodiment can easily change the optical path according to first-axis tilting and second-axis tilting, which will be described below.

The tilting guide unit 1141 may include first protrusions disposed to be spaced apart from each other in the first direction (the X-axis direction) and second protrusions disposed to be spaced apart from each other in the second direction (the Y-axis direction). In addition, the first protrusion and the second protrusion may protrude in opposite directions. The detailed description thereof will be given below.

In addition, as described above, the second magnet 1142 may be located in the second member 1131a. In addition, the first magnet 1143 may be located in the first member 1126.

The second magnet 1142 and the first magnet 1143 may have the same pole. For example, the second magnet 1142 may be a magnet having an N pole, and the first magnet 1143 may be a magnet having an N pole. Alternatively, the second magnet 1142 may be a magnet having an S pole, and the first magnet 1143 may be a magnet having an S pole. For example, as described above, a first pole surface of the first magnet 1143 and a second pole surface of the second magnet 1142, which faces the first pole surface, may have the same pole.

The second magnet 1142 and the first magnet 1143 may generate a repulsive force therebetween due to the above poles. With this configuration, the repulsive force may be applied to the second member 1131a or the holder 1131 coupled to the second magnet 1142 and the first member 1126 or the housing 1120 coupled to the first magnet 1143. In this case, the repulsive force applied to the second member 1131a may be transmitted to the holder 1131 coupled to the second member 1131a. Accordingly, the tilting guide unit 1141 disposed between the second member 1131a and the first member 1126 may be pressed by the repulsive force. Furthermore, the repulsive force may also be transmitted to the housing and the mover. Accordingly, the housing and the mover may be pressed by the repulsive force. That is, the repulsive force may correspond to a holding force that holds a location between the housing and the mover. In addition, the tilting guide unit may be in close contact with the first member 1126 and the holder 1131 by the repulsive force between the first magnet 1143 and the second magnet 1142. That is, the repulsive force generated by the first magnet 1143 and the second magnet 1142 may be a holding force for the location between the holder 1131 and the housing 1120. The detailed description thereof will be given below.

The driving unit 1150 includes the driving magnet 1151, the driving coil 1152, the Hall sensor unit 1153, the substrate unit 1154, and the yoke unit 1155. Description thereof will be made below. In addition, the yoke unit 1155 may be referred to as a “first yoke unit” in the first camera actuator. In addition, the yoke unit in the second camera actuator may be referred to as a “second yoke unit.”

Furthermore, the first camera actuator 1100 according to the embodiment may further include a shock absorption member PO. The shock absorption member PO may be formed of poron, rubber or sponge, silicone, etc. and may be in contact with the second member 1131a when the second member 1131a tilts. That is, the shock absorption member PO may absorb the shock of the movement of the second member 1131a, thereby improving the reliability of the second member 1131a. That is, the shock absorption member PO may be formed of a material having a damping force. In addition, the shock absorption member PO may serve as a stopper against the tilting of the second member 1131a.

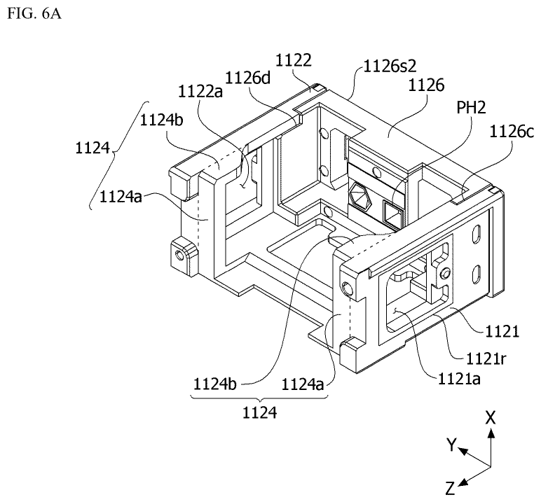

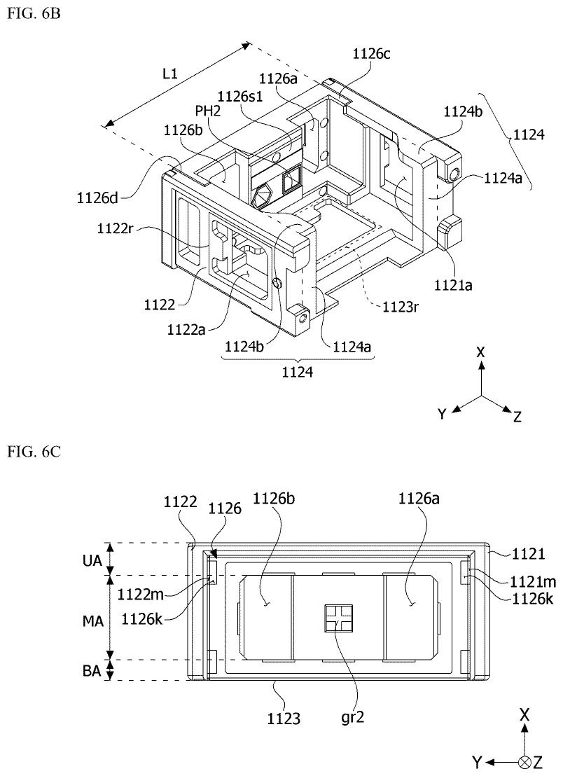

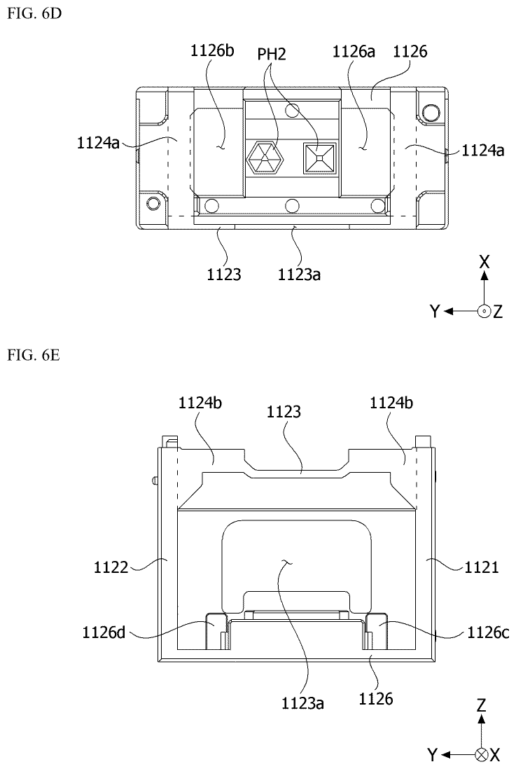

FIG. 6A is a perspective view of a first housing of the first camera actuator according to the embodiment, FIG. 6B is a perspective view of the first housing of the first camera actuator in a different direction from FIG. 6A, FIG. 6C is a front view of the first housing of the first camera actuator according to the embodiment, FIG. 6D is a rear view of the first housing of the first camera actuator according to the embodiment, and FIG. 6E is a top view of the first housing of the first camera actuator according to the embodiment.

Referring to FIGS. 6A to 6E, the housing 1120 according to the embodiment may include the first housing side portion 1121 to the third housing side portion 1123. In addition, the first member 1126 may be coupled integrally to the housing 1120. Accordingly, the first member 1126 may be a component included in the housing 1120. Alternatively, the housing 1120 may include the first member 1126.

The first housing side portion 1121 and the second housing side portion 1122 may be disposed to face each other. In addition, the first member 1126 and the housing wall 1124 may be disposed to face each other. Furthermore, the housing wall 1124 may also be applied to a structure of a camera actuator in which the first member and the second member do not exist in the same manner. That is, even in a structure in which the mover is tilted in the housing, a fixed housing may include the housing wall.

In addition, the third housing side portion 1123 may be disposed between the first housing side portion 1121 and the second housing side portion 1122.

The third housing side portion 1123 may be in contact with the first housing side portion 1121 and the second housing side portion 1122. In addition, the third housing side portion 1123 may be a lower surface of the housing 1120. In addition, the above contents may also be applied to the description of a direction in the same manner.

In addition, the first housing side portion 1121 may include a first housing hole 1121a. Accordingly, the first housing side portion 1121 and the second housing side portion 1122 of the housing 1120 may have a symmetrical shape. In addition, the housing 1120 may be structurally balanced. In addition, a coil may not exist in the first housing hole 1121a. Alternatively, as a modified example, the first housing hole 1121a may not exist.

In addition, the second housing side portion 1122 may include a second housing hole 1122a. In addition, a first coil to be described below may be located in the second housing hole 1122a.

In addition, the first housing side portion 1121 and the second housing side portion 1122 may be side surfaces of the housing 1120. In addition, the first coil may be coupled to a substrate unit. In an embodiment, the first coil may be electrically connected to the substrate unit so that a current may flow. The current is an element of an electromagnetic force capable of tilting the second camera actuator with respect to an X-axis.

In addition, the third housing side portion 1123 may include a third housing hole 1123a.

A second coil to be described below may be located in the third housing hole 1123a. The second coil may be located to face the second magnet. In addition, the second coil may be electrically connected and coupled to the substrate unit in contact with the housing 1120. Accordingly, the second coil may be electrically connected to the substrate unit to receive a current from the substrate unit. The current is an element of an electromagnetic force capable of tilting the second camera actuator with respect to a Y-axis.

The first member 1126 may be seated between the first housing side portion 1121 to the third housing side portion 1123. Accordingly, the first member 1126 may be located on the third housing side portion 1123. For example, the first member 1126 may be located at one side of the third housing side portion 1123. The first member 1126 and the holder may be sequentially located in the third direction.

In addition, the housing 1120 may include the accommodation unit 1125 formed by the first housing side portion 1121 to the third housing side portion 1123. The first member 1126, the second member, and the mover may be located in the accommodation unit 1125 as components. In addition, the mover, the tilting guide unit, etc. may be located in the accommodation unit 1125.

In addition, the housing 1120 may further include the housing wall 1124 facing the first member 1126. In addition, the housing wall 1124 may be disposed between the first housing side portion 1121 and the second housing side portion 1122 and may be in contact with the first housing side portion 1121, the second housing side portion 1122, and the third housing side portion 1123.

In addition, the housing wall 1124 may be located at ends of the first housing side portion 1121 and the second housing side portion 1122. That is, the housing wall 1124 may be provided as a plurality of housing walls. In addition, the plurality of housing walls 1124 may be located on the first housing side portion 1121 and the second housing side portion 1122, respectively. The plurality of housing walls 1124 may be spaced apart from each other in the second direction (the Y-axis direction). Accordingly, the light reflected from the optical member 1132 through a separation region may move to the second camera actuator located behind the camera module. That is, the separation region provides a path for light to move.

In addition, the housing wall 1124 may include protrusions, grooves, etc. to provide easy coupling with another camera actuator (the second camera actuator) adjacent thereto. With this configuration, it is possible to increase a coupling force between the housing wall 1124 having an opening providing the optical path and another component while providing the optical path, thereby suppressing movement of the opening due to separation and minimizing a change in optical path.

More specifically, the housing wall 1124 may be disposed on a side portion corresponding to a light-emitting surface of the optical member. In addition, the housing wall 1124 may be located between the first housing side portion 1121 and the second housing side portion 1122 and located at the ends of the first housing side portion 1121 and the second housing side portion 1122 in the optical axis direction. Accordingly, the housing wall 1124 may be located behind the accommodation unit 1125 in the optical axis direction. Furthermore, the housing wall 1124 may be located behind the optical member in the optical axis direction (the Z-axis direction).

In addition, the housing wall 1124 may overlap the holder in the optical axis direction (the Z-axis direction). In addition, at least a portion of the housing wall 1124 may overlap the holder in the optical axis direction. Here, the optical axis direction (the Z-axis direction) may correspond to a moving direction of the reflected light. In addition, the optical axis direction may correspond to a direction perpendicular to the light-emitting surface of the optical member. Accordingly, for a hand-shake prevention function, even when the mover, that is, the holder tilts, a movement amount may be limited by the housing wall 1124. Furthermore, the housing wall 1124 and the holder may collide with each other so that no shock occurs in the first member or the second member. Accordingly, it is possible to improve the reliability of the first member and the second member.

In addition, the housing wall 1124 may be formed integrally with the housing 1120. In addition, a portion of the housing wall 1124 may be formed of an elastic material. In addition, an elastic member may be additionally disposed on the housing wall 1124. Accordingly, it is possible to reduce a shock applied to the holder 1131 due to a collision between the housing wall 1124 and the holder 1131.

In addition, the housing wall 1124 according to the embodiment may include a wall 1124a facing (or corresponding to) the rear surface of the holder (or the light-emitting surface of the optical member) and a housing extension 1124b extending from the wall 1124a to an upper portion of the holder.

The wall 1124a may overlap the holder in the optical axis direction (the Z-axis direction). In addition, the housing extension 1124b may overlap the holder in the first direction.

The wall 1124a may serve as a stopper against the tilting of the holder in the first direction or the second direction. That is, when the holder tilts, the holder and the wall 1124a may collide with or come into contact with each other.

In addition, when the holder moves in the first direction or performs second-axis tilting (e.g., vertical driving), the housing extension 1124b may collide with or come into contact with the holder. That is, the housing extension 1124b may serve as a stopper against the movement of the holder in the first direction. Furthermore, the third housing side portion 1123 may also perform a stopper function.

In addition, as described above, the first member 1126 may be a component that is coupled to the housing 1120 and included in the housing 1120. For example, the first member 1126 may be a structure that is integrally formed with or separated from the first housing 1120. Hereinafter, the first member 1126 will be described as having a structure that is separated from the first housing 1120.

In addition, the first member 1126 may be disposed on the housing 1120. Alternatively, the first member 1126 may be located in the housing 1120.

In addition, the first member 1126 may be coupled to the housing 1120. In an embodiment, the first member 1126 may be located between the first housing side portion 1121 and the second housing side portion 1122. In addition, the first member 1126 may be located on the third housing side portion 1123 and may be in contact with the first housing side portion to the third housing side portion.

In addition, a first stop member may be located on an inner surface of the first housing side portion 1121. In addition, a second stop member may be located on an inner surface of the second housing side portion 1122.

The first stop member and the second stop member may be located symmetrically with respect to the first direction (the X-axis direction). The first stop member and the second stop member may extend in the first direction (the X-axis direction). With this configuration, even when the first member 1126 moves into the housing 1120, a location of the first member 1126 may be held by the first stop member and the second stop member.

That is, the first stop member and the second stop member may hold the location of the first member 1126 located at one side of the housing 1120.

Furthermore, the first stop member and the second stop member may fix the location of the first member 1126 to fix a location of the tilting guide unit between the first member 1126 and the mover, thereby eliminating error-causing factors, such as vibration. Accordingly, the first camera actuator according to the embodiment can accurately perform the X-axis tilting and the Y-axis tilting.

In addition, a separation distance between the first stop member and the second stop member in the second direction (the Y-axis direction) may be smaller than a maximum length L1 of the first member 1126 in the second direction (the Y-axis direction). Accordingly, the first member 1126 may be assembled or inserted into the side surface of the housing 1120 and coupled to the housing 1120. Furthermore, the holder may be assembled to the housing 1120 in the first direction. In addition, as described above, the first member 1126 may be coupled to the housing 1120 along a side surface of the housing 1120, that is, in the optical axis direction. In addition, the second member may be assembled or inserted into the housing 1120 in the optical axis direction. Accordingly, the second member may pass through the first member 1126. Thereafter, a plate may be further disposed on the first member 1126.

In addition, the first member 1126 includes a second protrusion groove PH2 in which the second protrusion of the tilting guide unit is seated. The second protrusion groove PH2 may be located in an inner surface 1126s1 of the first member 1126. As will be described below, the contents of the first protrusion groove may be applied to the second protrusion groove PH2 in the same manner. For example, the second protrusion groove PH2 may be provided as a plurality of second protrusion grooves and may have a structure having contact points that are the same as or different from those of the second protrusion of the tilting guide unit. For example, the number of second protrusion grooves PH2 is two, and the second protrusion groove PH2 may have a contact structure having a plurality of contact points. For example, the second protrusion groove PH2 may have a 4-point or 8-point contact structure. That is, the second protrusion groove PH2 may have a plurality of inclined surfaces. In addition, the second protrusion groove PH2 may also be a hemispherical groove.

In addition, in the first member 1126, the protrusion (e.g., the second protrusion) of the tilting guide unit is disposed adjacent to the optical member (the prism) in the third seating groove so that the protrusion, which is a reference axis of tilting, is disposed adjacent to the center of gravity of the mover 1130. Accordingly, when the holder tilts, it is possible to minimize a moment for moving the mover 1130 for tilting. Accordingly, it is also possible to minimize current consumption for driving the coil, thereby reducing the power consumption of the camera actuator.

In addition, the first member 1126 may include through-holes 1126a and 1126b. The through-hole may be provided as a plurality of through-holes and may include a first through-hole 1126a and a second through-hole 1126b.

First and second extensions of the second member, which will be described below, may pass through the first through-hole 1126a and the second through-hole 1126b, respectively. Accordingly, a holding force between the second member and the first member may be generated by the repulsive force between the first and second magnets. That is, even when the mover tilts, the location between the first housing and the mover may be held.

The second protrusion groove PH2 may be located between the first through-hole 1126a and the second through-hole 1126b. With this configuration, it is possible to increase the coupling force between the tilting guide unit 1141 and the first member 1126, thereby preventing a reduction in tilting accuracy caused by the movement of the tilting guide unit 1141 in the first housing.

In addition, the second groove gr2 may be located in an outer surface 1126s2 of the first member 1126. The first magnet may be seated in the second groove gr2. In addition, the outer surface 1126s2 of the first member 1126 may be opposite to or face an inner surface of the second member or a member base portion. Furthermore, the second magnet seated on the second member and the first magnet of the first member 1126 may face each other and generate the above repulsive force. Accordingly, since the first member 1126 presses the tilting guide unit inward or the holder by the repulsive force, the mover may be spaced a predetermined distance from the third housing side portion in the first housing even without current application to the coil. That is, the holding force for holding the location between the mover, the housing, and the tilting guide unit may be generated by the first magnet and the second magnet.

In addition, when the first member 1126 is formed integrally with the housing 1120, it is possible to increase the coupling force between the first member 1126 and the first housing 1120, thereby improving the reliability of the camera actuator. In addition, when the first member 1126 is formed separately from the housing 1120, it is possible to improve the ease of assembling and manufacturing of the first member 1126 and the housing 1120.

In addition, in an embodiment, the first member 1126 may include the first through-hole 1126a and the second through-hole 1126b as described above. In addition, the first through-hole 1126a and the second through-hole 1126b may be disposed side by side in the second direction (the Y-axis direction) and may overlap each other.

In addition, the first member 1126 may include upper members UA located above the first through-hole 1126a and the second through-hole 1126b and bottom members BA located under the first through-hole 1126a and the second through-hole 1126b. Accordingly, the first through-hole 1126a and the second through-hole 1126b may be located in the middle of the first member 1126. That is, the first member 1126 may include connection members MA located at side portions of the first through-hole 1126a and the second through-hole 1126b. That is, the upper member UA and the bottom member BA may be connected through the connection member MA. In addition, the bottom member BA may be provided as a plurality of bottom members to form the first and second through-holes and disposed to be spaced apart from each other in the second direction (the Y-axis direction).

Accordingly, the first member 1126 may have the upper member UA, thereby increasing stiffness. For example, it is possible to increase the stiffness of the first member 1126 compared to a case in which the upper member UA does not exist. For example, in the present embodiment, a unit of stiffness may be N/μm. Accordingly, it is possible to improve the reliability of the first camera actuator according to the embodiment.

In addition, a first coupling groove 1126k may be located in the outer surface 1126s2 of the first member 1126. The first coupling groove 1126k may be located at an edge of the outer surface 1126s2 of the first member 1126. In particular, the first coupling groove 1126k may be located at an end (e.g., left and right sides) of the outer surface 1126s2 of the first member 1126 and located adjacent to the first housing side portion 1121.

The first coupling groove 1126k may be located to correspond to second coupling grooves 1121m and 1122m of the first housing side portion 1121 and the second housing side portion 1122. In an embodiment, the first coupling groove 1126k may be located to correspond to (or face) the second coupling grooves 1121m and 1122m of the first housing side portion 1121 and the second housing side portion 1122. The second coupling grooves 1121m and 1122m may be located on side surfaces that are adjacent to the outer surface 1126s2 of the first member 1126 and are the same surface.

In an embodiment, the first coupling groove 1126k and the second coupling groove 1121m and 1122m may be provided as a plurality of grooves, and the plurality of first coupling grooves 1126k and the plurality of second coupling grooves 1121m and 1122m may be located symmetrically in the first direction or the second direction.

In addition, the first coupling groove 1126k and the second coupling grooves 1121m and 1122m may be coated with bonding members. That is, the bonding member may be coated between the first housing side portion (or the second housing side portion) and the first member 1126, thereby increasing the coupling force between the first housing 1120 and the first member 1126. The bonding member may include an epoxy, but is not limited to such a material.

In addition, the first member 1126 may further include a first protrusion 1126c and a second protrusion 1126d. The first protrusion 1126c may be in contact with the first housing side portion 1121, and the second protrusion 1126d may be in contact with the second housing side portion 1122. The first protrusion 1126c may extend from one end of the outer surface 1126s2 of the first member in the third direction (the Z-axis direction). The second protrusion 1126d may extend from the other end of the outer surface 1126s2 of the first member in the third direction (the Z-axis direction). That is, the first protrusion and the second protrusion may extend toward the holder.

A location of the first protrusion may be held by the first stop member, and a location of the second protrusion may be held by the second stop member. Accordingly, it is possible to improve the reliability of the camera actuator according to the embodiment.

In addition, as described above, the housing wall 1124 according to the embodiment may include the wall 1124a and the housing extension 1124b.

The housing wall 1124 or the wall 1124a may overlap a first through-hole 1126a and a second through-hole 1126b of the first member 1126 in the optical axis direction (the Z axis direction). For example, parts of the housing wall 1124 or the wall 1124a may overlap the first through-hole 1126a and the second through-hole 1126b of the first member 1126 in the optical axis direction (the Z axis direction).

In addition, the second protrusion groove PH2 may be located between the adjacent walls 1124a. In addition, the housing wall 1124 or the wall 1124a may not overlap the second protrusion groove PH2 in the optical axis direction (the Z-axis direction).

With this configuration, it is possible to increase an effective region of the light emitted after being reflected through the optical member located between the adjacent walls 1124a.

Furthermore, a distance (a separation distance in the second direction) between the adjacent housing extensions 1124b may decrease in the optical axis direction. With this configuration, it is possible to increase an amount of light incident to the optical member. Furthermore, the housing extension 1124b may sufficiently serve as a stopper against the tilting of the holder.

In addition, the third housing hole 1123a may be located between the adjacent housing extensions 1124b. That is, the third housing hole 1123a and the housing extension 1124b do not overlap each other in the first direction (X-axis direction) and may be misaligned.

In addition, at least one groove may be formed in the side portion of the housing 1120 according to the embodiment, which is in contact with the substrate unit 1154. For example, a first side portion groove 1121r may be located in the outer surface of the first housing side portion 1121. In addition, a second side portion groove 1122r may be located in the outer surface of the second housing side portion 1122. In addition, a third side portion groove 1123r may be located in the lower surface of the third housing side portion 1123.

The housing 1120 and the substrate unit 1154 may be bonded by coating the bonding member. In addition, the bonding member may be located between the housing 1120 and the substrate unit 1154. It is possible to increase a coupling force between the housing 1120 and the substrate unit 1154 by the first side portion groove 1121r, the second side portion groove 1122r, and the third side portion groove 1123r.

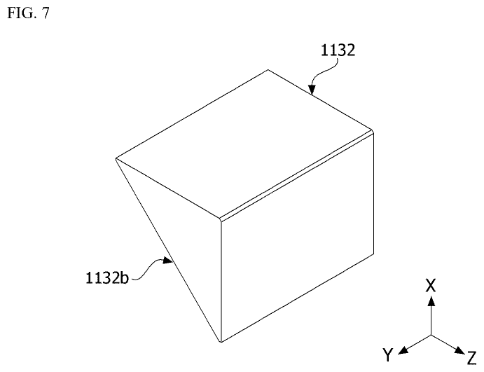

FIG. 7 is a perspective view of an optical member of the first camera actuator according to the embodiment.

The optical member 1132 may be seated on the holder. The optical member 1132 may be a right-angled prism as a reflector, but is not limited thereto.

As an embodiment, the optical member 1132 may have a protrusion (not illustrated) on a portion of an outer surface thereof. The optical member 1132 can be easily coupled to the holder through the protrusion (not illustrated). In addition, the holder may be coupled to the optical member 1132 by having a groove or a protrusion.

In addition, a lower surface 1132b of the optical member 1132 may be seated on the seating surface of the holder. Accordingly, the lower surface 1132b of the optical member 1132 may correspond to the seating surface of the holder. Furthermore, the lower surface 1132b of the optical member 1132 may be a reflective surface. In addition, an upper surface of the optical member 1132 may be an incident surface on which light is incident. In addition, a rear surface of the optical member 1132 may be an output surface through which light is output.

In addition, in an embodiment, the lower surface 1132b may be formed of an inclined surface in the same manner as the seating surface of the holder. Accordingly, it is possible to prevent the optical member 1132 from being separated from the holder due to the prism moving together according to the movement of the holder.

In addition, a groove may be formed in the lower surface 1132b of the optical member 1132 and the lower surface 1132b may be coated with the bonding member so that the optical member 1132 may be coupled to the holder. Alternatively, the groove or the protrusion of the holder may be coated with the bonding member so that the holder may be coupled to the optical member 1132.

In addition, the protrusion of the holder may face the housing wall to be described below. Furthermore, the protrusion of the holder may overlap the optical member 1132 in the optical axis direction. Accordingly, in the present embodiment, the protrusion of the holder may not overlap the housing wall in the optical axis direction.

In addition, as described above, the optical member 1132 may have a structure capable of reflecting the light reflected from the outside (e.g., an object) into the camera module. As in the embodiment, the optical member 1132 may be formed of a single mirror. In addition, the optical member 1132 can resolve the spatial limitations of the first camera actuator and the second camera actuator by changing the path of the reflected light. Accordingly, it should be understood that the camera module may provide a high range of magnification by extending the optical path while minimizing a thickness thereof.

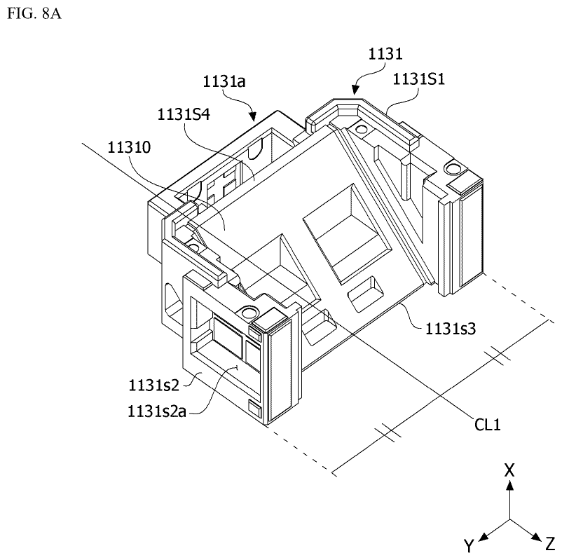

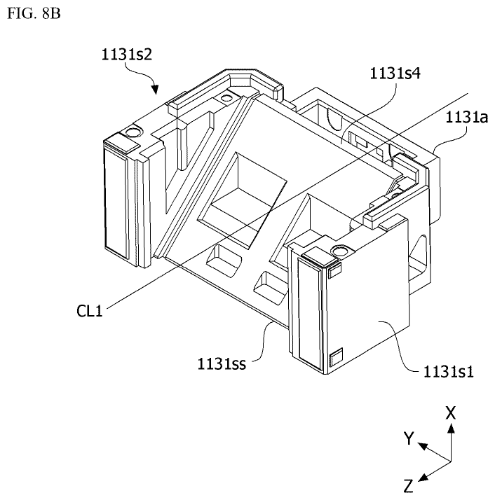

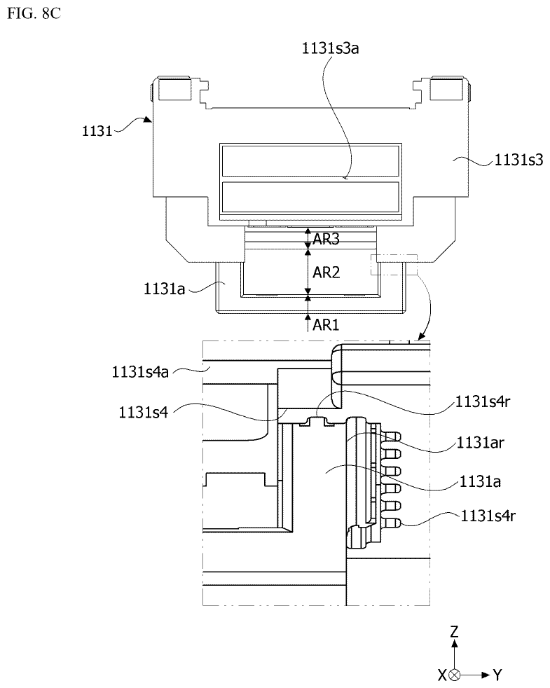

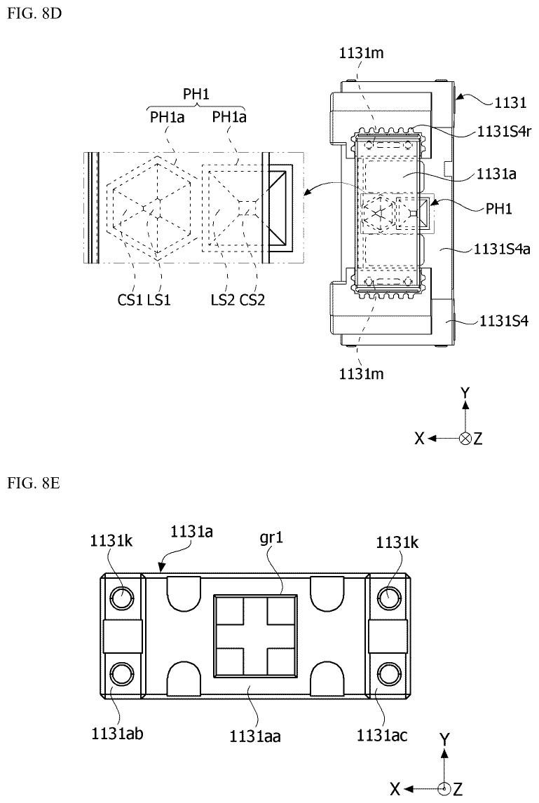

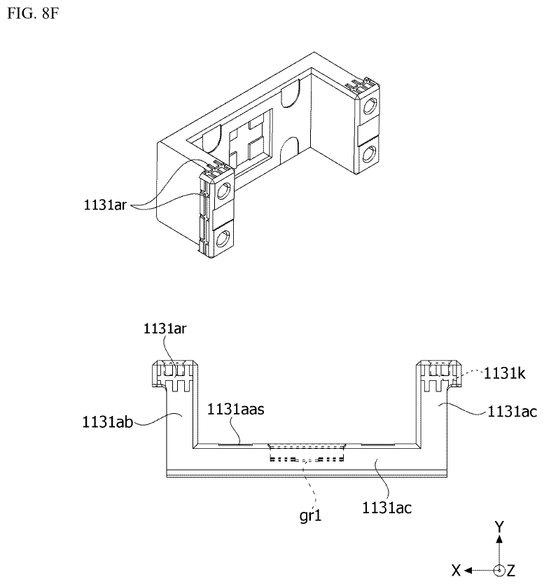

FIG. 8A is a perspective view of a holder of the first camera actuator according to the embodiment, FIG. 8B is a perspective view in a different direction from FIG. 8A, FIG. 8C is a bottom view of the holder of the first camera actuator according to the embodiment, FIG. 8D is a front view of the holder of the first camera actuator according to the embodiment, FIG. 8E is a rear view of a second member of the first camera actuator according to the embodiment, and FIG. 8F is a bottom view of the second member of the first camera actuator according to the embodiment.

Referring to FIGS. 8A to 8F, the holder 1131 may include a seating surface 11310 on which the optical member 1132 is seated. The seating surface 11310 may be an inclined surface. In addition, the holder 1131 may include a stepped portion above the seating surface 11310. In addition, the stepped portion of the holder 1131 may be coupled to the protrusion (not illustrated) of the optical member 1132.

The holder 1131 may be asymmetrical with respect to the optical axis direction. Alternatively, the holder 1131 may be asymmetrical with respect to the third direction (the Z-axis direction). In an embodiment, the holder 1131 may be asymmetrical with respect to a first line CL1. The first line CL1 may bisect the holder 1131 in the second direction (the Y-axis direction). In addition, the first line CL1 may be parallel to the optical axis direction or the third direction (the Z-axis direction).

Accordingly, when the holder 1131 is bisected by the first line CL1 or a plane perpendicular to the second direction, areas, volumes, and shapes of one side (one side portion) and the other side (the other side portion) may be different. With this configuration, even when the first magnet is disposed on only one of a first holder outer surface 1131S1 and a second holder outer surface 1131S2, the center of gravity of the holder 1131 may correspond to or may be similar to the optical axis. That is, the structural balance of the holder 1131 may be maintained. Furthermore, since the first magnet is disposed on only one side of the holder outer surface, the weight of the mover can be reduced, and the efficiency of the driving unit can also be increased.

For example, one side (side portion or region) adjacent to the first holder outer surface 1131S1 may have a greater area or volume than the other side (side portion or region). In addition, the first magnet may be located on only the second holder outer surface 1131S2.

The holder 1131 may include a plurality of outer surfaces. For example, the holder 1131 may include the first holder outer surface 1131S1, the second holder outer surface 1131S2, a third holder outer surface 1131S3, and a fourth holder outer surface 1131S4.

The first holder outer surface 1131S1 and the second holder outer surface 1131S2 may be located to face each other. That is, the first holder outer surface 1131S1 may be disposed symmetrically with the second holder outer surface 1131S2 with respect to the first direction (the X-axis direction).

The first holder outer surface 1131S1 may be located to correspond to the first housing side portion. That is, the first holder outer surface 1131S1 may be located to face the first housing side portion. In addition, the second holder outer surface 1131S2 may be located to correspond to the second housing side portion. That is, the second holder outer surface 1131S2 may be located to face the second housing side portion.

The second holder outer surface 1131S2 may include a first seating groove 1131S2a. The first holder outer surface 1131S1 may not have a groove or recess corresponding to the first seating groove. Accordingly, the first holder outer surface 1131S1 and the second holder outer surface 1131S2 may be asymmetrical with respect to the first line CL1.

A first magnet 1151a may be disposed in the first seating groove 1131S2a. In the present specification, it should be understood that the first magnet and the second magnet may be coupled to the housing through a yoke or a bonding member.

The third holder outer surface 1131S3 may be an outer surface that is in contact with the first holder outer surface 1131S1 and the second holder outer surface 1131S2 and extends from one sides of the first holder outer surface 1131S1 and the second holder outer surface 1131S2 in the second direction (the Y-axis direction). In addition, the third holder outer surface 1131S3 may be located between the first holder outer surface 1131S1 and the second holder outer surface 1131S2. The third holder outer surface 1131S3 may be the lower surface of the holder 1131. That is, the third holder outer surface 1131S3 may be located to face the third housing side portion.

In addition, the third holder outer surface 1131S3 may include a third seating groove 1131S3a. The second magnet may be disposed in the second seating groove 1131S3a. The third holder outer surface 1131S3 may be located to face the third housing side portion 1123.

In addition, at least a portion of the third housing hole 1123a may overlap the second seating groove 1131S3a in the first direction (the X-axis direction). Accordingly, the second magnet in the second seating groove 1131S3a and the second coil in the third housing hole 1123a may be located to face each other. In addition, the second magnet and the second coil may generate an electromagnetic force so that the second camera actuator may tilt with respect to the Y axis.

In addition, the X-axis tilting may be performed by the first magnet, while the Y-axis tilting may be performed by only the second magnet.

The fourth holder outer surface 1131S4 may be an outer surface that is in contact with the first holder outer surface 1131S1 and the second holder outer surface 1131S2 and extends from the first holder outer surface 1131S1 and the second holder outer surface 1131S2 in the first direction (the X-axis direction). In addition, the fourth holder outer surface 1131S4 may be located between the first holder outer surface 1131S1 and the second holder outer surface 1131S2. That is, the fourth holder outer surface 1131S4 may be located to face the first member.

The fourth holder outer surface 1131S4 may include a third seating groove 1131S4a. The tilting guide unit 1141 may be located in the third seating groove 1131S4a. In addition, the second member 1131a and the first member 1126 may be located in the third seating groove 1131S4a. In addition, the third seating groove 1131S4a may include a plurality of regions. The third seating groove 1131S4a may include a first region AR1, a second region AR2, and a third region AR3.

The second member 1131a may be located in the first region AR1. That is, the first region AR1 may overlap the second member 1131a in the first direction (the X-axis Attorney direction). In particular, the first region AR1 may be a region in which the member base portion of the second member 1131a is located. In this case, the first region AR1 may be located on the fourth holder outer surface 1131S4. That is, the first region AR1 may correspond to a region located above the third seating groove 1131S4a. In this case, the first region AR1 may not be one region in the third seating groove 1131S4a.

The first member 1126 may be located in the second region AR2. That is, the second region AR2 may overlap the first member 1126 in the first direction (the X-axis direction).

In addition, the second region AR2 may be located on the fourth holder outer surface 1131S4 like the first region. That is, the second region AR2 may correspond to a region located above the third seating groove 1131S4a.

The tilting guide unit may be located in the third region AR3. In particular, the base of the tilting guide unit may be located in the third region AR3. That is, the third region AR3 may overlap the tilting guide unit (e.g., the base) in the first direction (the X-axis direction).

In addition, the second region AR2 may be located between the first region AR1 and the third region AR3.

In addition, the second member may be disposed in the first region AR1, and the second member 1131a may include the first groove gr1. In an embodiment, the second member 1131a may include the first groove gr1 formed in an inner surface 1131aas. In addition, the second magnet may be disposed in the first groove gr1 as described above.

In addition, as described above, the first member may be disposed in the second region AR2. The first groove gr1 may be located to face the second groove. For example, at least a portion of the first groove gr1 may overlap the second groove in the third direction (the Z-axis direction).

In addition, the repulsive force generated by the second magnet may be transmitted to the third seating groove 1131S4a of the holder 1131 through the second member. Accordingly, the holder may apply a force to the tilting guide unit in the same direction as the repulsive force generated by the second magnet.

The first member may include the second groove facing the first groove gr1 formed in the outer surface thereof. In addition, the first member may include the second protrusion groove formed in the inner surface thereof as described above. In addition, the second protrusion may be seated in the second protrusion groove.

In addition, like the second magnet, the repulsive force generated by the first magnet and the second magnet may be applied to the first member. Accordingly, the first member and the second member may press the tilting guide unit disposed between the first member and the holder 1131 through the repulsive force.

The tilting guide unit 1141 may be disposed in the third region AR3.

In addition, the fourth holder outer surface 1131S4 may be in contact with the second member 1131a. The fourth holder outer surface 1131S4 may include a holder inner groove 1131S4r disposed in a surface that is in contact with or adjacent to the second member 1131a. The holder inner groove 1131S4r may be located to overlap the second member 1131a in the second direction (the Y-axis direction) and/or the third direction (the Z-axis direction). Furthermore, the second member 1131a may also include a member groove 1131ar formed in a surface that is in contact with or adjacent to the fourth holder outer surface 1131S4. The member groove 1131ar may overlap or may be misaligned with the holder inner groove 1131S4r in the second direction (the Y-axis direction) and/or the third direction (the Z-axis direction). Accordingly, it is possible to increase the coupling force between the second member 1131a and the holder 1131. That is, due to the above structure, a bonding area of the bonding member disposed between the second member 1131a and the holder 1131 may be increased.

In addition, since at least part of the second member 1131a and the holder 1131 are disposed to be misaligned, when the bonding member is separated, it is possible to easily secure a separation force of the second member 1131a. For example, the holder inner groove 1131S4r and the member groove 1131ar may have a partially misaligned structure to have a “+” shape.

In addition, a first protrusion groove PH1 may be located in the third seating groove 1131S4a. In addition, the first protrusion of the tilting guide unit 1141 may be accommodated in the first protrusion groove PH1. Accordingly, the first protrusion PR1 may be in contact with the first protrusion groove. A maximum diameter of the first protrusion groove PH1 may correspond to a maximum diameter of the first protrusion PR1. This may also be applied to the second protrusion groove and a second protrusion PR2 in the same manner. That is, a maximum diameter of the second protrusion groove may correspond to a maximum diameter of the second protrusion PR2. Accordingly, the second protrusion may be in contact with the second protrusion groove. With this configuration, first-axis tilting and second-axis tilting can be easily performed with respect to the first protrusion and the second protrusion, respectively, and a tilting radius can be increased.

In addition, in an embodiment, the first protrusion groove PH1 may be provided as a plurality of first protrusion grooves. For example, one of the first protrusion groove PH1 and the second protrusion groove PH2 may include a 1-1 protrusion groove PH1a and a 1-2 protrusion groove PH1b. Hereinafter, an example in which the first protrusion groove PH1 includes the 1-1 protrusion groove PH1a and the 1-2 protrusion groove PH1b will be described. In addition, the following description may also be applied to the second protrusion groove PH2 in the same manner. For example, the second protrusion groove PH2 may include a 2-1 protrusion groove and a 2-2 protrusion groove, in which the description of the 1-1 protrusion groove may be applied to the 2-1 protrusion groove, and the description of the 1-2 protrusion groove may be applied to the 2-2 protrusion groove.

The 1-1 protrusion groove PH1a and the 1-2 protrusion groove PH1b may be disposed side by side in the first direction (the X-axis direction). The 1-1 protrusion groove PH1a and the 1-2 protrusion groove PH1b may have the same maximum area or different maximum areas.

The plurality of first protrusion grooves PH1 may have the different number of inclined surfaces. For example, the first protrusion groove PH1 may include a groove lower surface and an inclined surface. In this case, the plurality of protrusion grooves may have the different number of inclined surfaces. In addition, areas of lower surfaces of the protrusion grooves may also be different.

For example, the 1-1 protrusion groove PH1a may include a first groove lower surface LS1 and a first inclined surface CS1. The 1-2 protrusion groove PH1b may include a second groove lower surface LS2 and a second inclined surface CS2.

In this case, areas of the first groove lower surface LS1 and the second groove lower surface LS2 may be different. The area of the first groove lower surface LS1 may be smaller than the area of the second groove lower surface LS2.

In addition, the number of first inclined surfaces CS1 in contact with the first groove lower surface LS1 may differ from the number of second inclined surfaces CS2. For example, the number of first inclined surfaces CS1 may be more than the number of second inclined surfaces CS2.

With this configuration, it is possible to easily compensate for an assembly tolerance of the first protrusion seated in the first protrusion groove PH1. For example, since the number of first inclined surfaces CS1 is more than the number of second inclined surfaces CS2, the first protrusion may be in contact with more inclined surfaces, thereby more accurately holding the location of the first protrusion in the 1-1 protrusion groove PH1a.

Unlike this, since the 1-2 protrusion groove PH1b has a smaller number of inclined surfaces in contact with the first protrusion than the 1-1 protrusion groove PH1a, the location of the first protrusion can be easily adjusted.

In an embodiment, the second inclined surfaces CS2 may be disposed to be spaced apart from each other in the second direction (the Y-axis direction). In addition, the second groove lower surface LS2 may extend in the first direction (the X-axis direction) so that the first protrusion can easily move in the first direction (the X-axis direction) while being in contact with the second inclined surface CS2. That is, the location of the first protrusion in the 1-2 protrusion groove PH1b can be easily adjusted. In addition, the first protrusion groove PH1 may be coated with a lubricating member.

In addition, in the present embodiment, heights of the first region AR1, the second region AR2, and the third region AR3 may be different in the first direction (the X-axis direction). In an embodiment, the height of the first region AR1 may be greater than those of the second region AR2 and the third region AR3 in the first direction (the X-axis direction). Accordingly, a stepped portion may be located between the first region AR1 and the second region AR2.

In addition, the second member 1131a may include the first groove gr1. That is, the first groove gr1 may be located in an inner surface of a member base portion 1131aa. In addition, the above second magnet may be seated in the first groove gr1. In addition, the first groove gr1 may be provided as a plurality of first grooves according to the number of second magnets. That is, the number of first grooves gr1 may correspond to the number of second magnets.

In addition, the second member 1131a may include the member base portion 1131aa, a first extension 1131ab, and a second extension 1131ac.

The member base portion 1131aa may be located at the outermost side of the first camera actuator. The member base portion 1131aa may be located outside the first member. That is, the first member may be located between the member base portion 1131aa and the tilting guide unit.

The first extension 1131ab may extend from an edge of the member base portion 1131aa in the third direction (the Z-axis direction). That is, the first extension 1131ab may extend from the member base portion 1131aa to the holder 1131. This is also applied to the second extension 1131ac in the same manner. In addition, the second extension 1131ac may extend from the edge of the member base portion 1131aa in the third direction (the Z-axis direction). In an embodiment, the first extension 1131ab and the second extension 1131ac may be located at the edge of the member base portion 1131aa in the second direction (the Y-axis direction). In addition, the first extension 1131ab and the second extension 1131ac may be disposed between an upper member and a lower member.

Accordingly, the second member 1131a may have a groove formed by the first extension 1131ab and the second extension 1131ac. That is, the groove may be located between the first extension 1131ab and the second extension 1131ac. Accordingly, the first extension 1131ab and the second extension 1131ac may be connected by only the member base portion 1131aa. With this configuration, the second member 1131a may continuously receive the repulsive force generated by the second magnet seated at a central portion of the member base portion 1131aa, particularly, in the first groove gr1.

In addition, the first extension 1131ab may be spaced apart from the second extension 1131ac in the second direction (the Y-axis direction) to form a separation space. The first member and the tilting guide unit may be seated in such a separation space. In addition, the second magnet and the first magnet may be located in the separation space.

In addition, the first extension 1131ab and the second extension 1131ac may have the same length in the third direction (the Z-axis direction). Accordingly, a coupling force, a weight, etc. can be formed in a balanced manner so that the tilting of the holder can be accurately performed without being biased to one side.

In addition, the first extension 1131ab and the second extension 1131ac may be coupled to the holder. In the present specification, it should be understood that coupling may be made through the bonding member other than the above protrusion and groove structures. In an embodiment, the first extension 1131ab and the second extension 1131ac may include a third coupling groove 1131k formed in the third direction (the Z-axis direction). In addition, a coupling protrusion 1131m may be located in a region in which the first extension 1131ab and the second extension 1131ac overlap each other in the third direction (the Z-axis direction) in the third seating groove 1131S4a. The coupling protrusion 1131mmay be located to correspond to the third coupling groove 1131k.

For example, the third coupling groove 1131k may be coated with the bonding member, such as an epoxy or the like. In addition, the coupling protrusion 1131m may be inserted into the third coupling groove 1131k of the first extension 1131ab and the second extension 1131ac. With this configuration, the second member 1131a and the holder 1131 may be coupled. In addition, the repulsive force applied to the second member 1131a may be transmitted to the holder 1131 through such coupling. However, it should be understood that the locations of the protrusion and groove structures may be interchanged as described above.

In addition, the second member 1131a may include the member groove 1131ar as described above. The member groove 1131ar may be located in the first extension 1131ab and the second extension 1131ac. In particular, the member groove 1131ar may be located in regions of the first extension 1131ab and the second extension 1131ac that are adjacent to the holder 1131. Accordingly, it is possible to increase the coupling force and separation force between the holder 1131 and the second member 1131a. Furthermore, it is possible to secure the reliability of the second member 1131a.

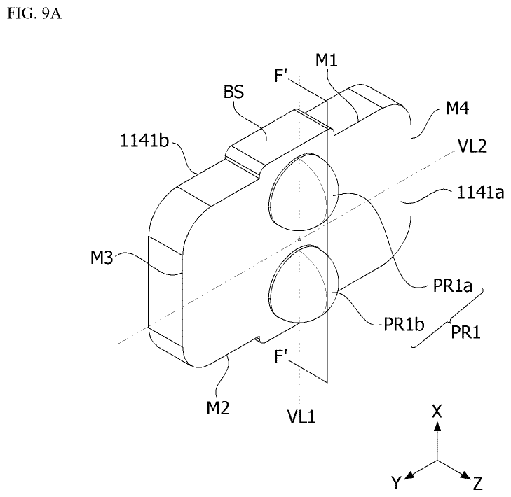

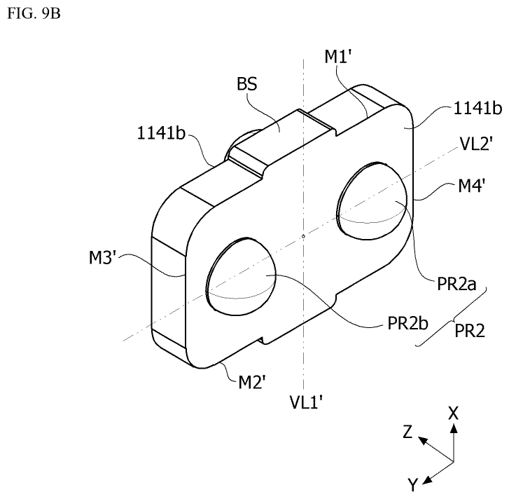

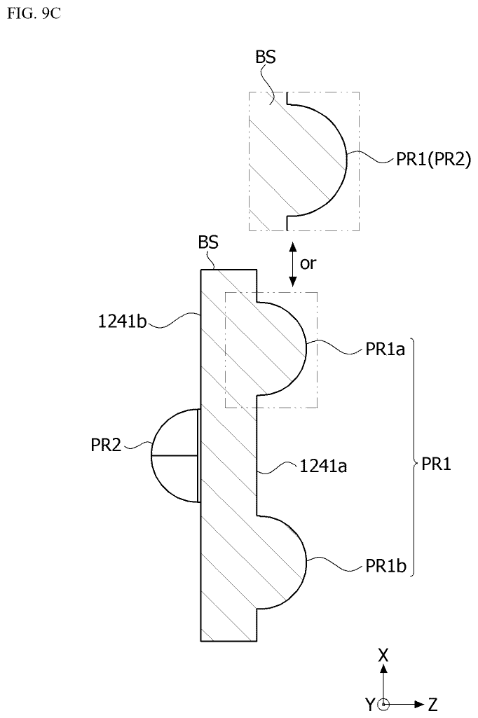

FIG. 9A is a perspective view of a tilting guide unit of the first camera actuator according to the embodiment, FIG. 9B is a perspective view in a different direction from FIG. 9A, and FIG. 9C is a view along line FF′ in FIG. 9A.

The tilting guide unit 1141 according to the embodiment may include a base BS, the first protrusion PR1 protruding from a first surface 1141a of the base BS, and the second protrusion PR2 protruding from a second surface 1141b of the base BS. In addition, the first protrusion and the second protrusion may be formed on opposite surfaces according to a structure, but will be described below based on the drawings. In addition, it should be understood that the first protrusion PRI and the second protrusion PR2 may be formed integrally with the base BS, and as illustrated in the drawings, the first protrusion PR1 and the second protrusion PR2 may have a spherical shape like a ball. In addition, the first protrusion PRI and the second protrusion PR2 may be a ball rather than a projection or protrusion shape.

First, the base BS may include the first surface 1141a and the second surface 1141b facing the first surface 1141a. That is, the first surface 1141a may be spaced apart from the second surface 1141b in the third direction (the Z-axis direction), and the first surface 1141a and the second surface 1141b may be outer surfaces opposite to or facing each other in the tilting guide unit 1141.

The tilting guide unit 1141 may include the first protrusion PRI extending to one side on the first surface 1141a. According to the embodiment, the first protrusion PR1 may protrude from the first surface 1141a to the holder. The first protrusion PRI may be provided as a plurality of first protrusions and may include a 1-1 protrusion PR1a and a 1-2 protrusion PR1b.

The 1-1 protrusion PR1a and the 1-2 protrusion PR1b may be located side by side in the first direction (the X-axis direction). That is, the 1-1 protrusion PR1a and the 1-2 protrusion PR1b may overlap each other in the first direction (the X-axis direction). In addition, in an embodiment, the 1-1 protrusion PR1a and the 1-2 protrusion PR1b may be bisected by a virtual line extending in the first direction (the X-axis direction).

In addition, the 1-1 protrusion PR1a and the 1-2 protrusion PR1b may have a curvature and have, for example, a hemispherical shape. In addition, the 1-1 protrusion PR1a and the 1-2 protrusion PR1b may be in contact with the first groove of the housing at a point which is the farthest from the first surface 1141a of the base BS.

In addition, the tilting guide unit 1141 may include the second protrusion PR2 extending to one side on the second surface 1141b. According to the embodiment, the second protrusion PR2 may protrude from the second surface 1141b toward the housing. In addition, the second protrusion PR2 may be provided as a plurality of second protrusions and may include a 2-1 protrusion PR2a and a 2-2 protrusion PR2b in the embodiment.

The 2-1 protrusion PR2a and the 2-2 protrusion PR2b may be located side by side in the second direction (the Y-axis direction). That is, the 2-1 protrusion PR2a and the 2-2 protrusion PR2b may overlap each other in the second direction (the Y-axis direction). In addition, in an embodiment, the 2-1 protrusion PR2a and the 2-2 protrusion PR2b may be bisected by a virtual line extending in the second direction (the Y-axis direction).

The 2-1 protrusion PR2a and the 2-2 protrusion PR2b may have a curvature and have, for example, a hemispherical shape. In addition, the 2-1 protrusion PR2a and the 2-2 protrusion PR2b may be in contact with the second member 1131a at a point which is spaced apart from the second surface 1141b of the base BS.

The 1-1 protrusion PR1a and the 1-2 protrusion PR1b may be located in a region between the 2-1 protrusion PR2a and the 2-2 protrusion PR2b in the second direction. According to the embodiment, the 1-1 protrusion PR1a and the 1-2 protrusion PR1b may be located at a central portion of a separation space between the 2-1 protrusion PR2a and the 2-2 protrusion PR2b in the second direction. With this configuration, the actuator according to the embodiment may have an angle of the X-axis tilting in the same range with respect to the X-axis. That is, the tilting guide unit 1141 and the holder may equally provide a range (e.g., a positive/negative range) in which the X-axis tilting may be performed with respect to the 1-1 protrusion PR1a and the 1-2 protrusion PR1b with respect to the X-axis.

In addition, the 2-1 protrusion PR2a and the 2-2 protrusion PR2b may be located in a region between the 1-1 protrusion PR1a and the 1-2 protrusion PR1b in the first direction. According to the embodiment, the 2-1 protrusion PR2a and the 2-2 protrusion PR2b may be located at a central portion of a separation space between the 1-1 protrusion PR1a and the 1-2 protrusion PR1b in the first direction. With this configuration, the actuator according to the embodiment may have an angle of the Y-axis tilting in the same range with respect to the Y-axis. That is, the tilting guide unit 1141 and the holder may equally provide a range (e.g., a positive/negative range) in which the Y-axis tilting may be performed with respect to the 2-1 protrusion PR2a and the 2-2 protrusion PR2b with respect to the Y-axis.

Specifically, the first surface 1141a may include a first outer line MI, a second outer line M2, a third outer line M3, and a fourth outer line M4. The first outer line MI and the second outer line M2 may face each other, and the third outer line M3 and the fourth outer line M4 may face each other. In addition, the third outer line M3 and the fourth outer line M4 may be located between the first outer line MI and the second outer line M2. In addition, the first outer line M1 and the second outer line M2 may be perpendicular to the first direction (the X-axis direction), but the third outer line M3 and the fourth outer line M4 may be parallel to the first direction (the X-axis direction).

In this case, the first protrusion PRI may be located on a first virtual line VL1. Here, the first virtual line VL1 is a line that bisects the first outer line M1 and the second outer line M2. Alternatively, the first and third virtual lines VL1 and VL1′ are lines that bisect the base BS in the second direction (the Y-axis direction). Accordingly, the tilting guide unit 1141 can easily perform the X-axis tilting through the first protrusion PR1. In addition, since the tilting guide unit 1141 performs the X-axis tilting with respect to the first virtual line VL1, a rotational force can be uniformly applied to the tilting guide unit 1141. Accordingly, it is possible to precisely perform the X-axis tilting and improve the reliability of the device.

In addition, the 1-1 protrusion PR1a and the 1-2 protrusion PR1b may be symmetrically disposed with respect to the first virtual line VL1 and a second virtual line VL2. Alternatively, the 1-1 protrusion PR1a and the 1-2 protrusion PR1b may be located symmetrically based on a first center point. With this configuration, during the X-axis tilting, a support force supported by the first protrusion PRI may be equally applied to upper and lower sides with respect to the second virtual line VL2. Accordingly, it is possible to improve the reliability of the tilting guide unit. Here, the second virtual line VL2 is a line which bisects the third outer line M3 and the fourth outer line M4. Alternatively, the second and fourth virtual lines VL2 and VL2′ are lines which bisect the base BS in the first direction (the X-axis direction).

In addition, the first center point may be an intersection of the first virtual line VL1 and the second virtual line VL2. Alternatively, the first center point may be a point corresponding to the center of gravity according to the shape of the tilting guide unit 1141.

In addition, the second surface 1141b may include a fifth outer line MI′, a sixth outer line M2′, a seventh outer line M3′, and an eighth outer line M4′. The fifth outer line M1′ and the sixth outer line M2′ may face each other, and the seventh outer line M3′ and the eighth outer line M4′ may face each other. In addition, the seventh outer line M3′ and the eighth outer line M4′ may be located between the fifth outer line M1′ and the sixth outer line M2′. In addition, the fifth outer line M1′ and the sixth outer line M2′ may be perpendicular to the first direction (the X-axis direction), but the seventh outer line M3′ and the eighth outer line M4′ may be parallel to the first direction (the X-axis direction).

In addition, since the tilting guide unit 1141 performs the Y-axis tilting with respect to the fourth virtual line VL2′, a rotating force can be uniformly applied to the tilting guide unit 1141. Accordingly, it is possible to precisely the Y-axis tilting and improve the reliability of the device.

In addition, the 2-1 protrusion PR2a and the 2-2 protrusion PR2b may be disposed symmetrically with respect to the third virtual line VL1′ on the fourth virtual line VL2′. Alternatively, the 2-1 protrusion PR2a and the 2-2 protrusion PR2b may be located symmetrically based on a second center point. With this configuration, during the Y-axis tilting, a support force supported by the second protrusion PR2 may be equally applied to upper and lower sides of the tilting guide unit with respect to the fourth virtual line VL2′. Accordingly, it is possible to improve the reliability of the tilting guide unit. Here, the third virtual line VL1′ is a line which bisects the fifth outer line MI′ and the sixth outer line M2′. In addition, the second center point may be an intersection of the third virtual line VL1′ and the fourth virtual line VL2′. Alternatively, the second center point may be a point corresponding to the center of gravity according to the shape of the tilting guide unit 1141.

In addition, a distance between the 1-1 protrusion PR1a and the 1-2 protrusion PR1b in the first direction (the X-axis direction) may be greater than a length of the second protrusion PR2 in the first direction (the X-axis direction). Accordingly, when the X-axis tilting is performed with respect to the 1-1 protrusion PR1a and the 1-2 protrusion PR1b, it is possible to minimize resistance due to the second protrusion PR2.

Correspondingly, a distance ML2 between the 2-1 protrusion PR2a and the 2-2 protrusion PR2b in the second direction (the Y-axis direction) may be greater than a length of the first protrusion PRI in the second direction (the Y-axis direction). Accordingly, when the Y-axis tilting is performed with respect to the 2-1 protrusion PR2a and the 2-2 protrusion PR2b, it is possible to minimize resistance due to the first protrusion PR1.

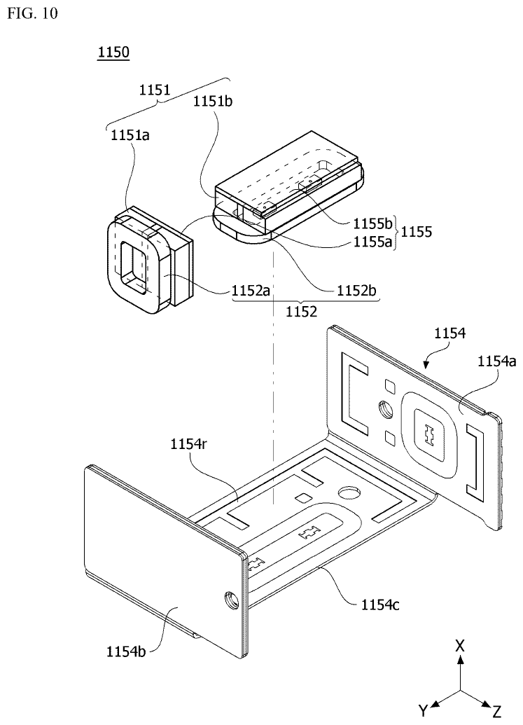

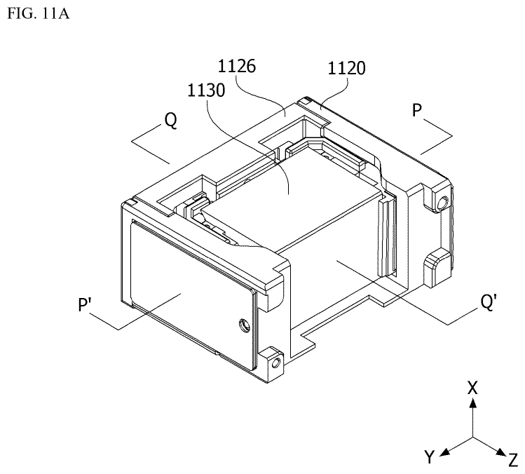

FIG. 10 is a view illustrating a first driving unit of the first camera actuator according to the embodiment.

Referring to FIG. 10, the driving unit 1150 includes the driving magnet 1151, the driving coil 1152, the Hall sensor unit 1153, the substrate unit 1154, and the yoke unit 1155.

In addition, as described above, the driving magnet 1151 may include a first magnet 1151a and a second magnet 1151b, which provide a driving force generated by an electromagnetic force. Each of the first magnet 1151a and the second magnet 1151b may be located on the outer surface of the holder 1131. The second magnet 1151b may be disposed below the first magnet 1151a. The second magnet 1151b may be disposed to be misaligned with the first magnet 1151a in the first direction.

In addition, the driving coil 1152 may include a plurality of coils. In an embodiment, the driving coil 1152 may include a first coil 1152a and a second coil 1152b.

In addition, the first coil 1152a may be located opposite to the first magnet 1151a. Alternatively, the first coil 1152a may be located to face the first magnet 1151a. Accordingly, as described above, the first coil 1152a may be located in the second housing hole 1122a of the second housing side portion 1122.

The second camera actuator according to the embodiment may control the mover 1130 to rotate along the first axis (in the X-axis direction) or the second axis (in the Y-axis direction) by the electromagnetic force between the driving magnet 1151 and the driving coil 1152, thereby minimizing the occurrence of a decentering or tilting phenomenon and providing the best optical characteristics during implementation of an OIS.

In addition, according to the embodiment, it is possible to provide an ultra-slim and ultra-small camera actuator and the camera module including the same by implementing the OIS through the tilting guide unit 1141 of the rotating unit 1140 disposed between the housing 1120 and the mover 1130 to resolve the size limitations of the actuator.

The substrate unit 1154 may include a first substrate side portion 1154a, a second substrate side portion 1154b, and a third substrate side portion 1154c.

The first substrate side portion 1154a and the second substrate side portion 1154b may be disposed to face each other. In addition, the third substrate side portion 1154c may be located between the first substrate side portion 1154a and the second substrate side portion 1154b.

In addition, the first substrate side portion 1154a may be located between the first housing side portion and the shield can, and the second substrate side portion 1154b may be located between the second housing side portion and the shield can. In addition, the third substrate side portion 1154c may be located between the third housing side portion and the shield can and may be a lower surface of the substrate unit 1154.

In addition, the first substrate side portion 1154a may be coupled and electrically connected to the first Hall sensor 1153a.

The second substrate side portion 1154b may be coupled and electrically connected to the first coil 1152a. In addition, it should be understood that the second substrate side portion 1154b may be coupled to and electrically connected to the first Hall sensor.

The third substrate side portion 1154c may be coupled and electrically connected to the second coil 1152b. In addition, the third substrate side portion 1154c may be coupled and electrically connected to a second Hall sensor 1153b.

The yoke unit 1155 may include a first yoke 1155a and a second yoke 1155b. In addition, the first yoke 1155a may be located in the first seating groove and coupled to the first magnet 1151a. In addition, the second yoke 1155b may be located in the second seating groove and coupled to the second magnet 1151b. The first yoke and the second yoke allow the first magnet and the second magnet to be easily seated in the first seating groove and the second seating groove and coupled to the housing.

In addition, at least one of the first substrate side portion 1154a, the second substrate side portion 1154b, and the third substrate side portion 1154c may include a substrate groove 1154r formed in an inner surface thereof. The substrate groove 1154r may be located on the outer surface of the substrate unit 1154. For example, the substrate groove 1154r may correspond to a structure in which a coverlay layer is exposed or open at the substrate unit 1154.

For example, the first substrate side portion 1154a may include the first substrate groove 1154r. The second substrate side portion 1154b may include the second substrate groove 1154r. The third substrate side portion 1154c may include the first substrate groove 1154r.

The first substrate side portion 1154a may be located on the first housing side portion. In addition, the first substrate groove 1154r may correspond to the first side portion groove.

In addition, the second substrate side portion 1154b may be located on the second housing side portion. In addition, the second substrate groove 1154r may correspond to the second side portion groove.

In addition, the third substrate side portion 1154c may be located on the third housing side portion. In addition, the third substrate groove 1154r may correspond to the third side portion groove.

With this configuration, it is possible to increase the coupling force between the substrate unit 1154 and the housing by the bonding member.

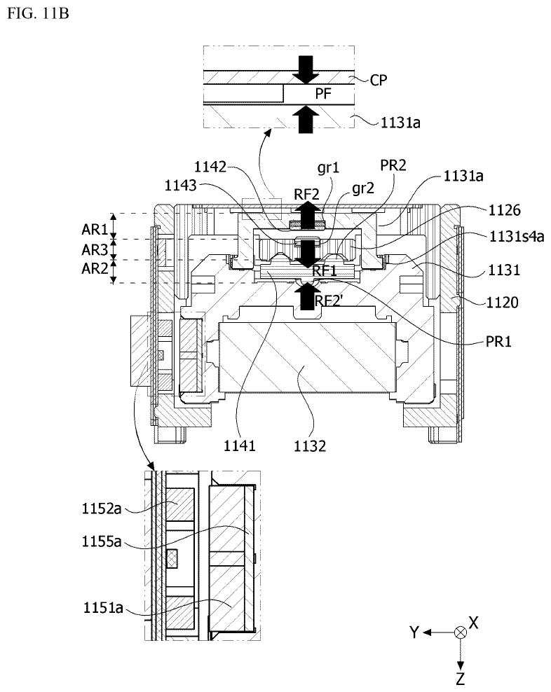

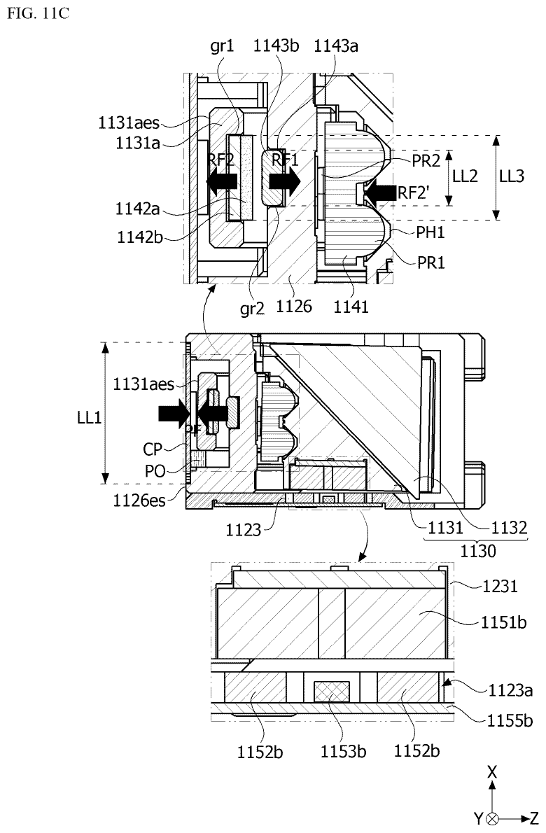

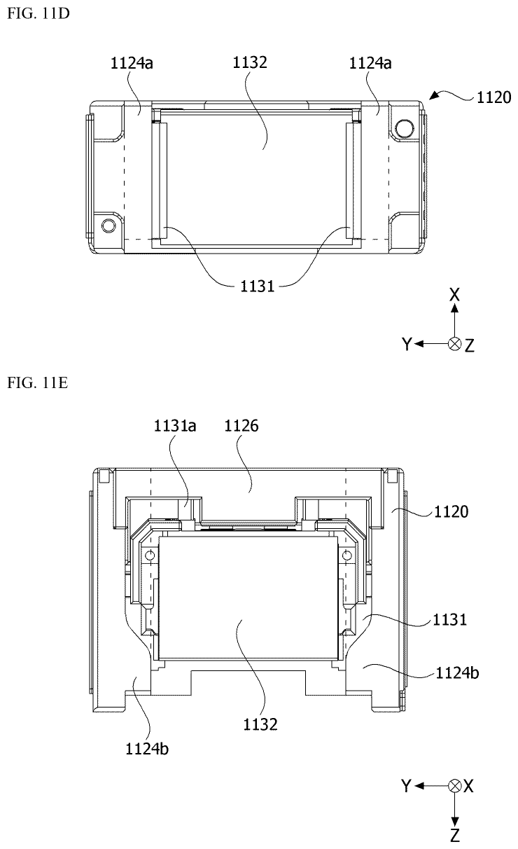

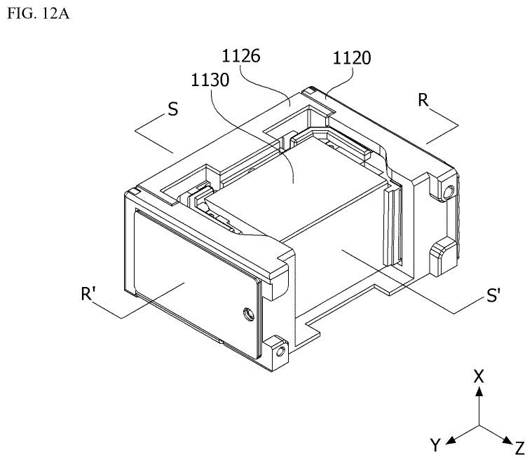

FIG. 11A is a perspective view of the first camera actuator according to the embodiment, FIG. 11B is a view along line PP′ in FIG. 11A, FIG. 11C is a view along line QQ′ in FIG. 11A, FIG. 11D is a rear view of the first camera actuator according to the embodiment, and FIG. 11E is a top view of the first camera actuator according to the embodiment.

Referring to FIGS. 11A to 11C, the first coil 1152a may be located on the second housing side portion 1122, and the first magnet 1151a may be located on the second holder outer surface 1131S2 of the holder 1131. Accordingly, the first coil 1152a and the first magnet 1151a may be located to face each other. At least a portion of the first magnet 1151a may overlap the first coil 1152a in the second direction (Y-axis direction).

The first coil 1152a may be located to correspond to the first magnet 1151a. Accordingly, the first coil 1152a may be located on only the housing side portion facing one of the first holder outer surface and the second holder outer surface. For example, the first magnet 1151a may be disposed on the second holder outer surface. In addition, the first coil 1152a may be located on the second housing side portion facing the second holder outer surface. Correspondingly, the substrate unit may be disposed on the second housing side portion. The second substrate side portion 1154b may be disposed on the second housing side portion.

Furthermore, the second coil 1152b may be located to correspond to the second magnet 1151b. The second magnet 1151b may be disposed on the third holder outer surface. In addition, the second coil 1152b may be located on the third housing side portion corresponding to the third holder outer surface. Accordingly, the substrate unit may be located on the third housing side portion. For example, the third substrate side portion 1154c may be disposed on the third housing side portion.

Likewise, the substrate unit may also be disposed on the housing side portion facing one of the first holder outer surface and the second holder outer surface. In addition, the substrate unit may also be asymmetrical with respect to the third direction corresponding to the asymmetry of the first holder outer surface and the second holder outer surface. In addition, the substrate unit may be asymmetrical with respect to the above first line.

In addition, the second protrusions PR2a and PR2b of the tilting guide unit 1141 may be in contact with the first member 1126 of the housing 1120. The second protrusion PR2 may be seated in the second protrusion groove PH2 formed in one side surface of the first member 1126. In addition, during the X-axis tilting, the second protrusions PR2a and PR2b may be reference axes (or rotational axes) for tilting. Accordingly, the tilting guide unit 1141 and the mover 1130 may move in the second direction.

In addition, as described above, the first Hall sensor 1153a may be located outside to be electrically connected and coupled to the substrate unit 1154. However, the embodiments of the present invention are not limited to such a location.

In addition, the second coil 1152b may be located on the third housing side portion 1123, and the second magnet 1151b may be located on the third holder outer surface 1131S3 of the holder 1131. At least parts of the second coil 1152b and the second magnet 1151b may overlap each other in the first direction (the X-axis direction). Accordingly, a strength of the electromagnetic force between the second coil 1152b and the second magnet 1151b can be easily controlled.

As described above, the tilting guide unit 1141 may be located on the fourth holder outer surface 1131S4 of the holder 1131. In addition, the tilting guide unit 1141 may be seated in the third seating groove 1131S4a of the fourth holder outer surface. As described above, the third seating groove 1131S4a may include the first region AR1, the second region AR2, and the third region AR3.

The second member 1131a may be disposed in the first region AR1, and the second member 1131a may include the first groove gr1 formed in the inner surface of the second member 1131a. In addition, as described above, the second magnet 1142 may be disposed in the first groove gr1, and a repulsive force RF2 generated by the second magnet 1142 may be transmitted to the third seating groove 1131S4a of the holder 1131 through the second member 1131a (RF2′). Accordingly, the holder 1131 may apply a force to the tilting guide unit 1141 in the same direction as the repulsive force RF2 generated by the second magnet 1142.

The first member 1126 may be disposed in the second region AR2. The first member 1126 may include the second groove gr2 facing the first groove gr1. In addition, the first member 1126 may include the second protrusion groove PH2 disposed in the surface corresponding to the second groove gr2. In addition, a repulsive force RF1 generated by the first magnet 1143 may be applied to the first member 1126. Accordingly, the first member 1126 and the second member 1131a may press the tilting guide unit 1141 disposed between the first member 1126 and the holder 1131 through the generated repulsive forces RF1 and RF2′. Accordingly, even after the holder is tilted with respect to the X-axis or the Y-axis by a current applied to the first coil or the second coil, coupling (locations) between the holder 1131, the housing 1120, and the tilting guide unit 1141 may be maintained.

The tilting guide unit 1141 may be disposed in the third region AR3. As described above, the tilting guide unit 1141 may include the first protrusion PRI and the second protrusion PR2. In this case, the first protrusion PRI and the second protrusion PR2 may be disposed on the second surface 1141b and the first surface 1141a of the base BS, respectively. In this way, even in other embodiments, which will be described below, the first protrusion PRI and the second protrusion PR2 may be located at various locations on surfaces facing the base.

The first protrusion groove PH1 may be located in the third seating groove 1131S4a. In addition, the first protrusion PR1 of the tilting guide unit 1141 may be accommodated in the first protrusion groove PH1. Accordingly, the first protrusion PR1 may be in contact with the first protrusion groove PH1. The maximum diameter of the first protrusion groove PH1 may correspond to the maximum diameter of the first protrusion PR1. This may also be applied to the second protrusion groove PH2 and the second protrusion PR2 in the same manner. With this configuration, the first-axis tilting and the second-axis tilting can be easily performed with respect to the first protrusion PR1 and the second protrusion PR2, respectively, and a tilting radius can be increased.

In addition, the tilting guide unit 1141 may be disposed side by side with the second member 1131a and the first member 1126 in the third direction (the Z-axis direction) so that the tilting guide unit 1141 may overlap the optical member 1132 in the first direction (the X-axis direction). More specifically, in the embodiment, the first protrusion PR1 may overlap the optical member 1132 in the first direction (the X-axis direction). Furthermore, at least a portion of the first protrusion PRI may overlap the second coil 1152b or the second magnet 1151b in the first direction (the X-axis direction). That is, in the camera actuator according to the embodiment, each protrusion, which is the central axis of the tilting, may be located adjacent to the center of gravity of the mover 1130. Accordingly, the tilting guide unit may be located adjacent to the center of gravity of the holder. Accordingly, the camera actuator according to the embodiment can minimize a moment value for tilting the holder and also minimize the consumption of the current applied to the coil or the like to tilt the holder, thereby improving power consumption and device reliability.

In addition, the second magnet 1142 and the first magnet 1143 may not overlap the second coil 1152b or the optical member 1132 in the first direction (the X-axis direction). That is, in the embodiment, the second magnet 1142 and the first magnet 1143 may be disposed to be spaced apart from the second coil 1152b or the optical member 1132 in the third direction (the Z-axis direction). Accordingly, it is possible to minimize the magnetic force received by the second coil 1152b from the second magnet 1142 and the first magnet 1143. Accordingly, according to the camera actuator according to the embodiment, it is possible to easily perform vertical driving (the Y-axis tilting) and minimize power consumption.

Furthermore, as described above, the second Hall sensor 1153b located inside the second coil 1152b may detect a change in magnetic flux to perform location sensing between the second magnet 1151b and the second Hall sensor 1153b. In this case, an offset voltage of the second Hall sensor 1153b may vary according to the influence of the magnetic field generated by the second magnet 1142 and the first magnet 1143.

The first camera actuator according to the embodiment may include the second member 1131a, the second magnet 1142, the first magnet 1143, the first member 1126, and the tilting guide unit 1141, and the holder 1131 in the third direction, which may be sequentially disposed based on the outermost surface thereof. However, since the second magnet is located on the second member and the first magnet is located on the first member, the second member, the first member, the tilting guide unit, and the holder may be sequentially disposed.

In addition, in an embodiment, separation distances of the second magnet 1142 and the first magnet 1143 from the holder 1131 (or the optical member 1132) in the third direction may be greater than separation distances between the tilting guide units 1141. Accordingly, the second Hall sensor 1153b under the holder 1131 may also be disposed to be spaced a predetermined distance from the second magnet 1142 and the first magnet 1143. Accordingly, it is possible to minimize the influence of the magnetic field generated by the second magnet 1142 and the first magnet 1143 on the second Hall sensor 1153b, thereby preventing the Hall voltage from being saturated by being concentrated to a positive or negative value. That is, such a configuration may allow a Hall electrode to have a range in which Hall calibration may be performed. Furthermore, a temperature also affects the electrode of the Hall sensor, and resolution power of a camera lens varies according to the temperature, but in the embodiment, it is possible to prevent the case in which the Hall voltage is concentrated to the positive or negative value to compensate for the resolution power of the lens correspondingly, thereby easily preventing the degradation of the resolution power.

In addition, a circuit for compensating for the offset with respect to the output (i.e., the Hall voltage) of the second Hall sensor 1153b can also be easily designed.

In addition, according to the embodiment, a portion of the tilting guide unit 1141 may be located outward more than the fourth holder outer surface of the holder 1131.

The tilting guide unit 1141 excluding the first protrusion PR1 and the second protrusion PR2 may be seated in the third seating groove 1131S4a with respect to the base. That is, a length of the base in the third direction (the Z-axis direction) may be smaller than a length of the third seating groove 1131S4a in the third direction (the Z-axis direction). With this configuration, it is possible to easily achieve miniaturization.

In addition, a maximum length of the tilting guide unit 1141 in the third direction (the Z-axis direction) may be greater than a length of the third seating groove 1131S4a in the third direction (the Z-axis direction). Accordingly, as described above, an end of the second protrusion PR2 may be located between the fourth holder outer surface and the first member 1126. That is, at least a portion of the second protrusion PR2 may be located in a direction opposite to the third direction (the Z-axis direction) more than the holder 1131. That is, the holder 1131 may be spaced a predetermined distance from the end (the portion being in Attorney contact with the second protrusion groove) of the second protrusion PR2 in the third direction (the Z-axis direction).

In addition, a front surface 1131aes of the second member 1131a according to the embodiment may be spaced apart from a front surface 1126es of the first member 1126. In particular, the front surface 1131aes of the second member 1131a according to the embodiment may be located from the front surface 1126es of the first member 1126 in the third direction (the Z-axis direction). Alternatively, the front surface 1131aes of the second member 1131a according to the embodiment may be located inside the front surface 1126es of the first member 1126. To this end, the first member 1126 may have an inward extending and bent structure. In addition, a portion of the second member 1131a may be located in a groove formed by the extending and bent structure of the first member 1126.

With this configuration, since the second member 1131a is located inside the first member 1126, it is possible to increase space efficiency and achieve miniaturization. Furthermore, even when the driving (tilting or rotation of the mover 1130) by the electromagnetic force is performed, the second member 1131a does not protrude outward from the first member 1126 and thus can be blocked from being in contact with peripheral devices. Accordingly, it is possible to improve reliability.

In addition, a predetermined separation space may exist between the second magnet 1142 and the first magnet 1143. That is, the second magnet 1142 and the first magnet 1143 may face each other with the same pole.

Further referring to FIGS. 11D and 11E, in the first camera actuator according to the embodiment, the first magnet may be located in the housing 1120, and the second magnet may be located in the mover 1130.

As described above, according to the embodiment, the first magnet and the second magnet may be located facing each other to generate a repulsive force. The repulsive force is a holding force, and the location between the housing 1120 and the mover 1130 may be maintained by such a repulsive force.

More specifically, the first member 1126 may include the second groove gr2 disposed in the outer surface thereof. The first magnet 1143 may be located in the second groove gr2. In addition, the second groove gr2 may be located at a side (or a surface) opposite to the second protrusion groove and the first member 1126.

In addition, the second member 1131a may include the first groove gr1 facing the second groove gr2. The first groove gr1 may be located in the inner surface of the second member 1131a. In addition, the second magnet 1142 may be located in the first groove gr1.

In addition, the first member 1126 may be disposed at one side of the housing 1120. In addition, the second member 1131a may pass through the first member 1126 and may be coupled in contact with the holder 1131. Accordingly, the tilting guide unit 1141 may be disposed between the first member 1126 and the mover 131 (or the holder).

In addition, the second magnet 1142, the first magnet 1143, and the tilting guide unit 1141 may be disposed sequentially in the optical axis direction (the Z-axis direction). Furthermore, the second magnet 1142, the first magnet 1143, and the tilting guide unit 1141 may overlap each other in the optical axis direction (the Z-axis direction).

Furthermore, the plate CP may be located on the outer surface of the first member 1126. Accordingly, the plate CP, the second magnet 1142, and the first magnet 1143 may be disposed sequentially in the optical axis direction.

In addition, the plate CP may have a length LL1 in the first direction (the X-axis direction), which is greater than a length LL2 of the second magnet 1142 in the first direction (the X-axis direction). In addition, the length LL2 of the second magnet 1142 in the first direction (the X-axis direction) may differ from a length LL3 of the first magnet 1143 in the first direction (the X-axis direction). For example, the length LL2 of the second magnet 1142 in the first direction (the X-axis direction) may be greater than the length LL3 of the first magnet 1143 in the first direction (the X-axis direction). In addition, an area XY of the plate CP may be greater than an area (an XY plane) of the first member 1126 or an area (an XY plane) of the second member 1131a. Furthermore, the plate CP may be a non-magnet as described above. Accordingly, the plate CP can suppress foreign substances from flowing into the first member 1126, the second member 1131a, the first magnet 1143, the second magnet 1142, etc. that are disposed inside the housing 1120.

In addition, the plate CP may be formed of a magnet. In this case, the plate CP may generate a magnetic force with the second magnet 1142. For example, an attractive force may be generated between the plate CP and the second magnet 1142. For example, the plate CP may generate an attractive force with the second magnet 1142 as a yoke. Accordingly, the attractive force generated between the plate CP and the second magnet 1142 may reinforce the above repulsive force. Accordingly, it is possible to further increase the holding force between the mover and the housing. In addition, it is possible to improve the reliability of the first camera actuator with the increased holding force. For example, the second magnet 1142 has a surface (or a region) 1142a that faces the first magnet 1143 and has the same pole as one surface 1143b of the first magnet 1143. In addition, the second magnet 1142 may have a surface 1142b that faces the plate CP and has a different pole from the plate CP. In this case, the plate CP may be formed of a magnet. Furthermore, the second magnet 1142 may have the one surface 1143b and the other surface 1143a that have different poles. Such description will be given based on a case in which the first magnet 1143 and the second magnet 1142 are magnets.

With this configuration, the repulsive force between the second magnet 1142 and the first magnet 1143 can be further increased by the plate CP. That is, an attractive force PF may be generated between the second magnet 1142 and the plate CP. Furthermore, the plate CP may be formed of a magnet, such as a metal, and may block leakage of a magnetic flux. For example, the plate CP can prevent leakage of the magnetic flux caused by the first magnet 1143 or the second magnet 1142. Accordingly, the plate CP can improve the electrical reliability of the first camera actuator.

In addition, the wall 1124a of the housing wall 1124 may not overlap with the optical member 1132 in the optical axis direction. In addition, the wall 1124a of the housing wall 1124 may be misaligned with the optical member 1132 in the optical axis direction.

In addition, the housing wall 1124 may overlap the holder in the optical axis direction (the Z-axis direction). Accordingly, for a hand-shake prevention function, even when the mover, that is, the holder tilts, a movement amount may be limited by the housing wall 1124. Furthermore, the housing wall 1124 and the holder may collide with each other so that no shock occurs in the first member or the second member. Accordingly, it is possible to improve the reliability of the first member and the second member.

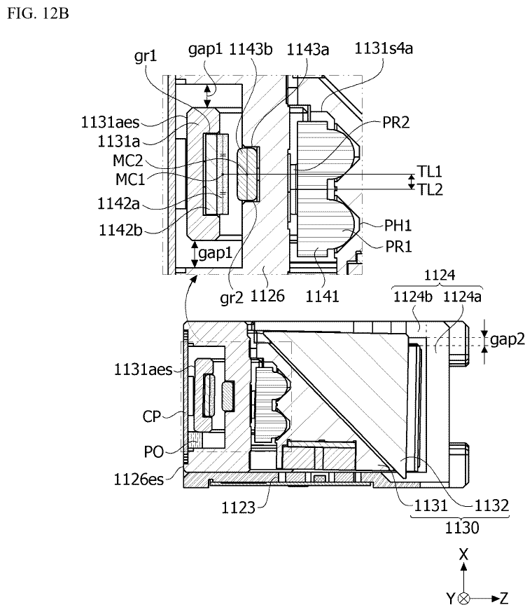

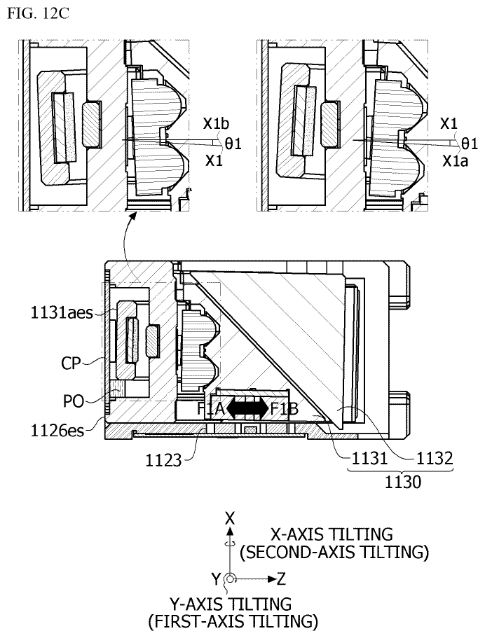

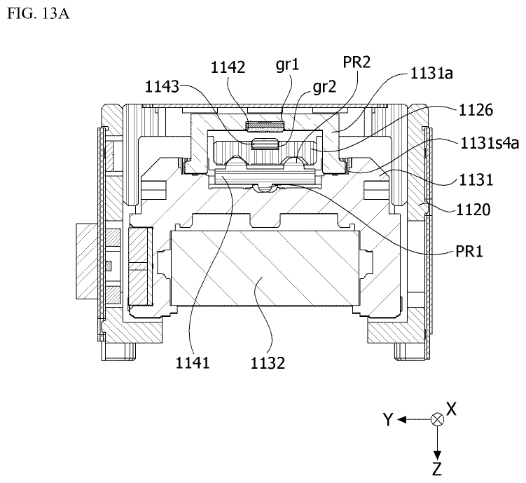

FIG. 12A is a perspective view of the first camera actuator according to the embodiment, FIG. 12B is a view along line SS′ in FIG. 12A, and FIG. 12C is an exemplary view of movement of the first camera actuator illustrated in FIG. 12B.

Referring to FIGS. 12A to 12C, the Y-axis tilting may be performed by the first camera actuator according to the embodiment. That is, an OIS may be implemented by rotating the first camera actuator in the first direction (the X-axis direction).

In an embodiment, the second magnet 1151b disposed under the holder 1131 may generate an electromagnetic force with the second coil 1152b to tilt or rotate the mover 1130 with respect to the second direction (the Y-axis direction).

Specifically, the repulsive force between the second magnet 1142 and the first magnet 1143 may be transmitted to the second member 1131a and the first member 1126 and ultimately transmitted to the tilting guide unit 1141 disposed between the first member 1126 and the holder 1131. Accordingly, the tilting guide unit 1141 may be pressed by the mover 1130 and the housing 1120 by the above repulsive force.

In addition, the second protrusion PR2 may be supported by the first member 1126. In this case, in an embodiment, the tilting guide unit 1141 may rotate or tilt using the second protrusion PR2 protruding toward the first member 1126 as a reference axis (or a rotational axis), that is, with respect to the second direction (the Y-axis direction). That is, the tilting guide unit 1141 may rotate or tilt using the second protrusion PR2 protruding toward the first member 1126 in the first direction (the X-axis direction) as the reference axis (or the rotational axis).

For example, an OIS may be implemented by rotating (X1→X1a) the mover 130 at a first angle θ1 in the X-axis direction by first electromagnetic forces F1A and F1B between the second magnet 1151b disposed in the second seating groove and the second coil 1152b disposed on the third substrate side portion.

Conversely, an OIS may be implemented by rotating (X1→X1b) the mover 130 at the first angle θ1 in a direction opposite to the X-axis direction by the first electromagnetic forces F1A and F1B between the second magnet 1151b disposed in the second seating groove and the second coil 1152b disposed on the third substrate side portion.

The first angle θ1 may range from ±1° to ±3°. However, the embodiments of the present invention are not limited thereto.

Hereinafter, in the first camera actuators according to various embodiments, the electromagnetic force may move the mover by generating a force in the described direction or move the mover in the described direction even when a force is generated in another direction. That is, the described direction of the electromagnetic force is a direction of the force generated by the magnet and the coil to move the mover. For example, the first electromagnetic forces F1A and F1B may act in a third direction or in a direction opposite to the third direction.

In addition, a center MC1 of the second magnet 1142 and a center MC2 of the first magnet 1143 may be disposed side by side in the third direction (the Z-axis direction). That is, a center line TL1 connecting the center MC1 of the second magnet 1142 to the center MC2 of the first magnet 1143 may be parallel to the third direction (the Z-axis direction).

In addition, a bisector TL2 that bisects the second protrusion PR2 and corresponds to the third direction (the Z-axis direction) may be parallel to the center line TL1 (or the bisector). That is, the bisector TL2 may be a line that bisects the second protrusion PR2 in the first direction (the X-axis direction) and may be provided as a plurality of bisectors.

In an embodiment, the bisector TL2 may be disposed to be spaced apart from the center line TL1 in the first direction (the X-axis direction). The bisector TL2 may be located above the center line TL1. With this configuration, since a separation distance between the second coil 1152b and the second magnet 1151b may be increased, the holder can more accurately perform two axes tilting. Furthermore, when a current is not applied to the coil, the location of the holder can be held equally.

More specifically, since the center MC1 of the second magnet 1142 and the center MC2 of the first magnet 1143 are spaced apart from the bisector TL2 in the first direction (the X-axis direction), the force (e.g., the repulsive force) between the second magnet 1142 and the first magnet 1143 may act at a position spaced a distance from the bisector TL2 corresponding to the optical axis in the first direction (the X-axis direction). In addition, a momentum is generated in the mover 1130 by such a force. However, when the center MC1 of the second magnet 1142 and the center MC2 of the first magnet 1143 are located on the bisector TL2, there is a problem that, during calibration, the locations of the tilting guide unit and the second magnet 1142 are not held after tilting. That is, in the camera actuator according to the embodiment, since the center MC1 of the second magnet 1142 and the center MC2 of the first magnet 1143 are not disposed on or do not overlap the bisector TL2, the locations of the tilting guide unit and the second magnet 1142 may be held after tilting or rotating.

In another embodiment, the center MC1 of the second magnet 1142 and the center MC2 of the first magnet 1143 may be disposed to be spaced apart from each other in the first direction (the X-axis direction).

In addition, the center MC1 of the second magnet 1142 and the center MC2 of the first magnet 1143 may not be located on the bisector TL2. For example, the center MC1 of the second magnet 1142 and the center MC2 of the first magnet 1143 may be located above the bisector TL2.

Accordingly, since the separation distance between the second coil 1152b and the second magnet 1151b increases, the holder can more accurately perform two axes tilting. Furthermore, when a current is not applied to the coil, the location of the holder can be held equally.

In addition, the lengths of the second magnet 1142 and the first magnet 1143 may be different in the first direction (the X-axis direction).

In an embodiment, the area of the second magnet 1142 that is coupled to the second member 1131a and tilts along with the mover 1130 may be greater than the area of the first magnet 1143. For example, a length of the second magnet 1142 in the first direction (the X-axis direction) may be greater than a length of the first magnet 1143 in the first direction (the X-axis direction). In addition, a length of the second magnet 1142 in the second direction (the Y-axis direction) may be greater than a length of the first magnet 1143 in the second direction (the Y-axis direction). In addition, the first magnet 1143 may be located in a virtual straight line extending both ends of the second magnet 1142 in the third direction.

With this configuration, even when the magnet at one side (e.g., the second magnet) tilts during tilting or rotating, it is possible to easily prevent forces other than the vertical force from being generated by the tilting. That is, even when the second magnet vertically tilts along with the mover 1130, the second magnet may not receive a force (e.g., a repulsive force or an attractive force) against the tilting from the first magnet 1143. Accordingly, it is possible to increase driving efficiency.

In addition, when the housing wall (the wall or the housing extension) is in contact with the holder 1131, the housing (excluding the housing wall) may be spaced a predetermined distance from the holder 1131. That is, when the holder 1131 tilts, the holder 1131 may primarily collide with the housing wall. Accordingly, it is possible to improve the reliability of the housing 1120 and the holder 1131. Specifically, when the housing wall (the wall or the housing extension) is in contact with the holder 1131, the first member 1126 may be spaced a predetermined distance from the second member 1131a. Accordingly, it is possible to eliminate the shock applied to the first member 1126 and the second member 1131a.

In an embodiment, when the holder 1131 tilts, the holder 1131 may collide with the housing wall or the housing sequentially or simultaneously in a plurality of regions.

When the holder 1131 tilts, the holder 1131 may primarily collide with the wall (collision 2 and collision 3), and then secondarily collide with the housing extension or the third housing side portion (or the wall) (collision 1 and collision 4). Accordingly, the third housing side portion may be in contact with the housing wall. In addition, a length of the third housing side portion in the optical axis direction may be greater than a length of the optical member 1132 in the optical axis direction. With this configuration, shock between the holder and the housing due to tilting does not occur in the first member and the second member, and it is possible to increase shock absorption efficiency.

In addition, when the holder 1131 tilts, the holder 1131 may primarily collide with the housing extension or the third housing side portion (or the wall) (collision 1 and collision 4), and then secondarily collide with the wall (collision 2 and collision 3). Accordingly, the third housing side portion may be in contact with the housing wall. Likewise, the length of the third housing side portion in the optical axis direction may be greater than the length of the optical member 1132 in the optical axis direction. With this configuration, shock between the holder and the housing due to tilting does not occur in the first member and the second member, and it is possible to increase shock absorption efficiency.

In addition, when the holder 1131 tilts, the holder 1131 may simultaneously collide with the housing extension, the third housing side portion (or the wall), or the like in a plurality of regions (collision 1 and collision 2 may occur simultaneously, or collision 3 and collision 4 may occur simultaneously).

Furthermore, with the above configuration, as described above, even when the mover 1130 rotates (X1→X1a or X1b) along the X-axis at the first angle θ1 by the first electromagnetic forces F1A and F1B, the collision between the first member 1126 and the second member 1131a may not occur. That is, the collision between the holder 1131 and the housing wall 1124 may occur preferentially. Accordingly, it is possible to suppress the collision between the first member 1126 and the second member 1131a, thereby improving the reliability of the first member 1126 and the second member 1131a of which locations are held to implement an OIS. Accordingly, it is possible to improve the reliability of the first camera actuator.

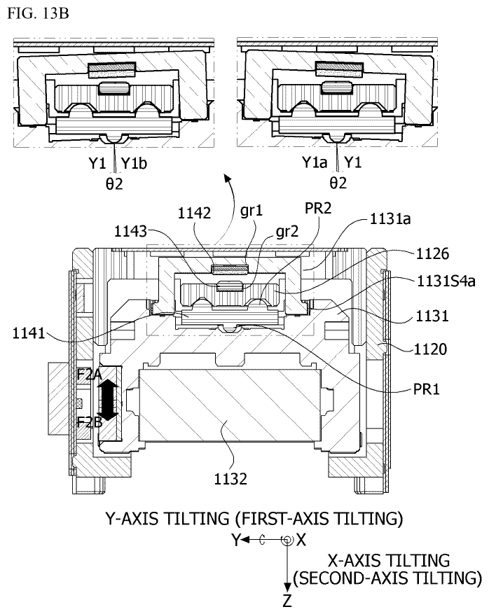

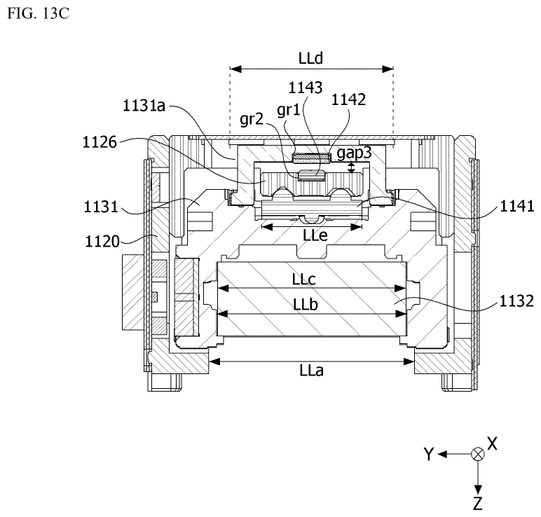

FIG. 13A is a view along line RR′ in FIG. 12A, FIG. 13B is an exemplary view of movement of the first camera actuator illustrated in FIG. 13A, and FIG. 13C is a view illustrating a collision of a housing wall with respect to the movement of the first camera actuator illustrated in FIG. 13A.

Referring to FIGS. 13A and 13B, X-axis tilting may be performed. That is, an OIS may be implemented by tilting or rotating the mover 1130 in the Y-axis direction.

In an embodiment, the first magnet 1151a disposed under the holder 1131 may generate the electromagnetic force with the first coil 1152a to tilt or rotate the tilting guide unit 1141 and the mover 1130 in the first direction (the X-axis direction).

Specifically, the repulsive force between the second magnet 1142 and the first magnet 1143 may be transmitted to the first member 1126 and the holder 1131 and ultimately transmitted to the tilting guide unit 1141 disposed between the holder 1131 and the first member 1126. Accordingly, the tilting guide unit 1141 may be pressed by the mover 1130 and the housing 1120 by the above repulsive force.

In addition, the 1-1 protrusion PR1a and the 1-2 protrusion PR1b may be spaced apart from each other in the first direction (the X-axis direction) and supported by the first protrusion groove PH1 formed in the third seating groove 1131S4a of the holder 1131. In addition, in an embodiment, the tilting guide unit 1141 may rotate or tilt with respect to the first protrusion PR1 protruding toward the holder 1131 (e.g., in the third direction), which is the reference axis (or the rotational axis), that is, with respect to the first direction (the X-axis direction).

For example, an OIS may be implemented by rotating (Y1→Y1a or Y1b) the mover 130 at a second angle θ2 in the Y-axis direction by the second electromagnetic forces F2A and F2B between the first magnet 1151a and the first coil 1152a disposed on the first substrate side portion.

The second angle θ2 may range from ±1° to 3°. However, the embodiments of the present invention are not limited thereto.

In addition, as described above, the electromagnetic force generated by the first magnet 1151a and the first coil 1152a may act in the third direction or in a direction opposite to the third direction. For example, the electromagnetic force may be generated on a left side portion of the mover 1130 in the third direction (the Z-axis direction) and may act on a right side portion of the mover 1130 in a direction opposite to the third direction (the Z-axis direction). Accordingly, the mover 1130 may rotate with respect to the first direction. Alternatively, the mover 130 may move in the second direction.

As described above, the second camera actuator according to the embodiment may control the mover 1130 to rotate in the first direction (the X-axis direction) or the second direction (the Y-axis direction) by the electromagnetic force between the driving magnet in the holder and the driving coil disposed in the first housing, thereby minimizing the occurrence of a decentering or tilting phenomenon and providing the best optical characteristics during the implementation of the OIS. In addition, as described above, “Y-axis tilting” refers to rotation or tilting in the first direction (the X-axis direction), and “X-axis tilting” refers to rotation or tilting in the second direction (the Y-axis direction) According to the embodiment, the wall 1124a of the housing wall 1124 may not overlap the optical member 1132 in the optical axis direction. That is, the wall 1124a of the housing wall 1124 may be misaligned with the optical member 1132 in the optical axis direction. In addition, a distance LLa between adjacent walls 1124a in the second direction may be greater than a length LLb of the seating surface of the holder 1131 in the second direction. In addition, the distance LLa between the adjacent walls 1124a in the second direction may be greater than a length LLc of the optical member 1132 in the second direction. Accordingly, it is possible to prevent the collision between the optical member 1132 and the wall 1124a, thereby preventing damage to the optical member 1132. Furthermore, the light emitted through the optical member 1132 cannot be blocked by the wall 1124a.

In a modified example, a portion of the housing wall 1124 may overlap the optical member 1132 in the optical axis direction. In this case, the housing wall 1124 and the optical member 1132 may not be in contact with each other. That is, even when the mover tilts, the housing wall 1124 and the optical member 1132 may not be in contact with each other. In addition, even when the mover maximally tilts, the housing wall 1124 and the optical member 1132 may be spaced apart from each other.

In addition, the housing wall 1124 or the wall 1124a may overlap the first magnet 1151a in the optical axis direction (the Z-axis direction). Accordingly, the shock caused by the first magnet 1151a having a relatively large weight can be easily absorbed by the wall 1124a.

In addition, the distance LLa between the adjacent walls 1124a in the second direction may be greater than the length LLd of the second member 1131a in the second direction. In addition, the distance LLa between the adjacent walls 1124a in the second direction may be greater than a length LLe of the tilting guide unit 1141 in the second direction. Accordingly, the housing wall 1124 and the second member 1131a may not overlap each other in the optical axis direction (the Z-axis direction). The housing wall 1124 and the second member 1131a may be misaligned in the optical axis direction (the Z-axis direction).

With this configuration, an effective region of the optical member 1132 can be maximized. In addition, the holder 1131 may have a small rotation radius for driving of an OS, thereby miniaturizing the camera actuator.

In an embodiment, a distance between the first magnet 1143 and the second magnet 1142 may be greater than a distance between the holder 1131 and the housing wall 1124. In addition, even when the holder 1131 tilts, a distance between the first groove and the second groove may be greater than the distance between the holder 1131 and the housing wall 1124. Furthermore, even when the holder 1131 tilts and the housing wall and the holder 1131 are in contact with each other, the first groove and the second groove may be spaced apart from each other. With this configuration, even when the holder 1131 is moved by movement or shock of the holder 1131, a collision between the holder 1131 and the housing wall 1124 may primarily occur. Accordingly, it is possible to suppress the occurrence of shock on the first member and the second member by which a holding force is generated for rotation. Accordingly, it is possible to improve the reliability of the first member and the second member, thereby improving the reliability of the first camera actuator.

In addition, when the housing wall (the wall or the housing extension) is in contact with the holder 1131, the housing (excluding the housing wall) may be spaced a predetermined distance from the holder 1131. That is, when the holder 1131 tilts, the holder 1131 may first collide with the housing wall. Accordingly, it is possible to improve the reliability of the housing 1120 and the holder 1131. Specifically, when the housing wall (the wall or the housing extension) is in contact with the holder 1131, the first member 1126 may be spaced a predetermined distance from the second member 1131a. Accordingly, it is possible to eliminate the shock applied to the first member 1126 and the second member 1131a.

In addition, the housing wall 1124 may not overlap the first magnet 1143 or the second magnet 1142 in the optical axis direction.

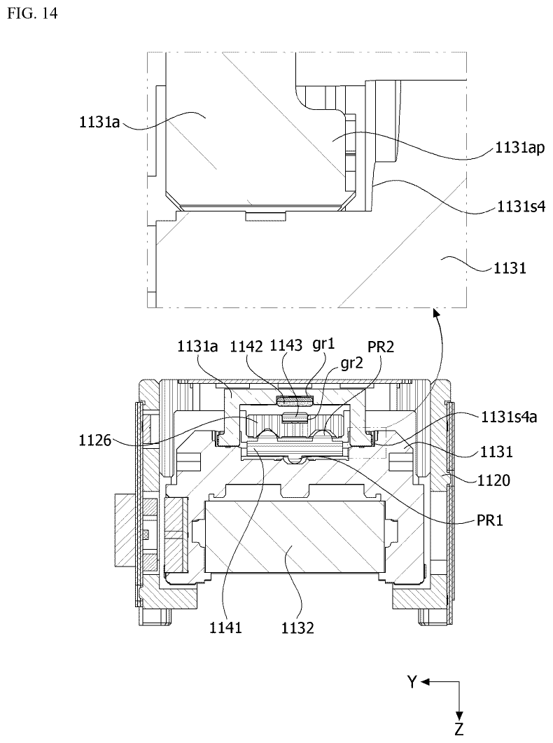

FIG. 14 is a cross-sectional view of the first camera actuator according to a modified example.

Referring to FIG. 14, the first camera actuator according to the modified example may include a housing, a mover, a rotating unit, a driving unit, a first member, a second member, a plate, and a shock absorption member. In the present embodiment, it should be understood that the description of the housing, the mover, the rotating unit, the driving unit, the first member, the second member, the plate, and the shock absorption member of the first camera actuator according to various embodiments, which will be described herein, may be applied in the same manner unless being contradictory.

In the present embodiment, the second member 1131a may be seated on the fourth holder outer surface 1131S4 of the holder 1131. In addition, the second member 1131a may be coupled to the fourth holder outer surface 1131S4 by the bonding member.

In addition, as described above, the second member 1131a may include a member base portion, a first extension, and a second extension. In an embodiment, at least one of the first extension and the second extension may include a member protrusion 1131ap extending outward. A member groove may also be disposed in the member protrusion 1131ap.

Due to the member protrusion 1131ap, the first extension and the second extension may have a stepped structure. In addition, due to the member protrusion 1131ap, a space that the bonding member is coated or inserted may exist between the fourth holder outer surface 1131S4 and the second member 1131a. Accordingly, the second member 1131a may be completely covered with the bonding member. Accordingly, the assembly process can be easy, and the coupling force between the second member 1131a and the holder 1131 can be increased.

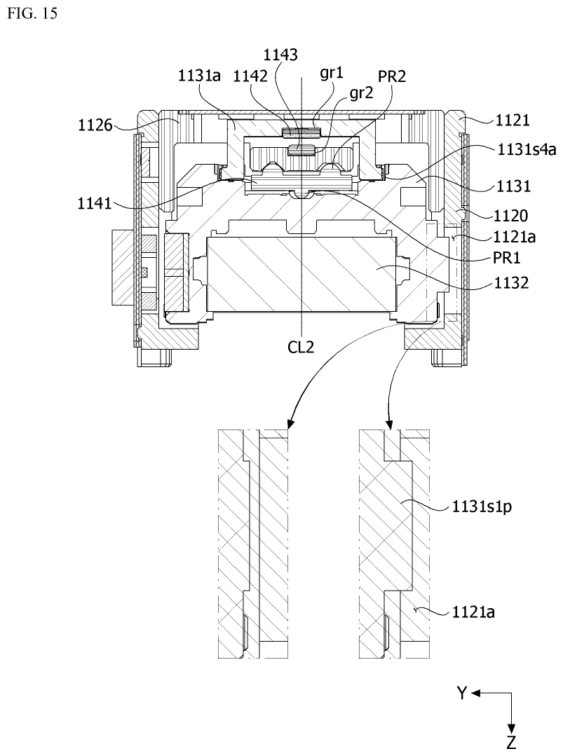

FIG. 15 is a cross-sectional view of a first camera actuator according to another embodiment.

Referring to FIG. 15, the first camera actuator according to the modified example may include a housing, a mover, a rotating unit, a driving unit, a first member, a second member, a plate, and a shock absorption member. In the present embodiment, it should be understood that the description of the housing, the mover, the rotating unit, the driving unit, the first member, the second member, the plate, and the shock absorption member of the first camera actuator according to various embodiments, which will be described herein, may be applied in the same manner unless being contradictory.

In addition, in the present embodiment, the holder 1131 may have a first magnet disposed on the second holder outer surface. In addition, the first holder outer surface may extend outward. For example, the holder 1131 may include a holder protrusion 1131S1p extending or protruding to the first housing side portion 1121. The holder protrusion 1131S1p may be located adjacent to the first housing side portion 1121.

For example, the holder protrusion 1131S1p may be disposed to be spaced a predetermined distance from the first housing side portion 1121 in the second direction.

In addition, a portion of the holder protrusion 1131S1p may overlap the first housing side portion 1121 in the third direction. That is, the holder protrusion 1131S1p may pass through the first housing hole 1121a of the first housing side portion 1121. However, the holder protrusion 1131S1p may be disposed to be spaced a predetermined distance from the first substrate side portion located on the first housing side portion 1121. The holder protrusion 1131S1p may be disposed to be spaced a predetermined distance from the first substrate side portion located on the first housing side portion 1121 in the second direction.

In addition, the holder 1131 may have an asymmetrical shape with respect to a second line CL2. For example, both side portions of the holder 1131 may be different in weight, volume, area, and shape with respect to the second line CL2. The second line CL2 may be a line that bisects the housing, the second member, the first member, and the like in the second direction. The second line CL2 may correspond to the optical axis.

A maximum distance to the first holder outer surface and a maximum distance to the second holder outer surface may be different with respect to the second line CL2. For example, the maximum distance to the first holder outer surface may be greater than the maximum distance to the second holder outer surface with respect to the second line CL2.

Furthermore, when the holder 1131 tilts with respect to the first direction, the holder protrusion 1131S1p may be in contact with the first housing side portion 1121 or the first substrate side portion.

With this configuration, even when the first magnet is disposed on some of the outer surfaces of the holder 1131, the structural balance of the holder 1131 can be maintained. Furthermore, since the first magnet is disposed on only one side of the holder outer surface, it is possible to achieve weight reduction and low cost of the mover and increase the efficiency of the driving unit.

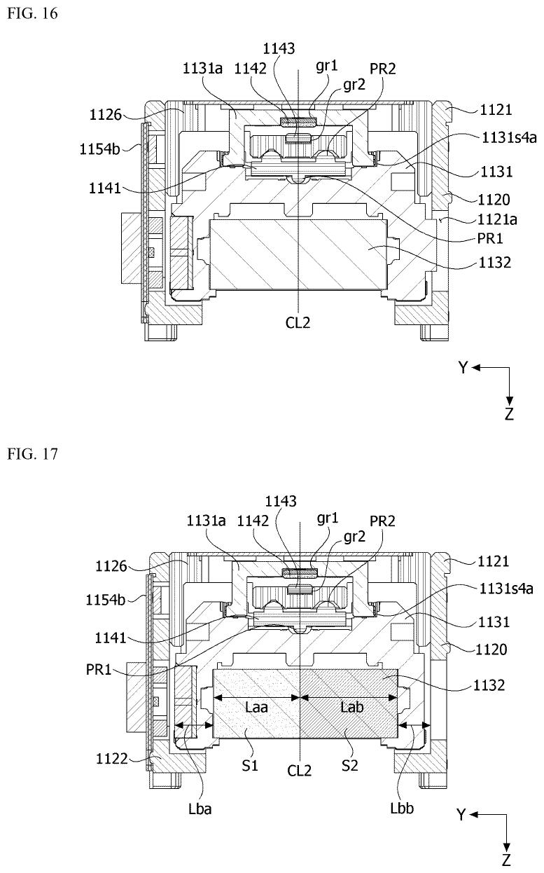

FIG. 16 is a cross-sectional view of a first camera actuator according to still another embodiment.

Referring to FIG. 16, the first camera actuator according to still another embodiment may include a housing, a mover, a rotating unit, a driving unit, a first member, a second member, a plate, and a shock absorption member. In the present embodiment, it should be understood that the description of the housing, the mover, the rotating unit, the driving unit, the first member, the second member, the plate, and the shock absorption member of the first camera actuator according to various embodiments, which will be described herein, may be applied in the same manner unless being contradictory.

In the embodiment, the substrate unit may not include the above-described first substrate side portion. The substrate unit may include the second substrate side portion 1154b and the third substrate side portion 1154c. Accordingly, the substrate unit may be asymmetrical with respect to the third direction (the Z-axis direction), the optical axis, or the second line CL2.

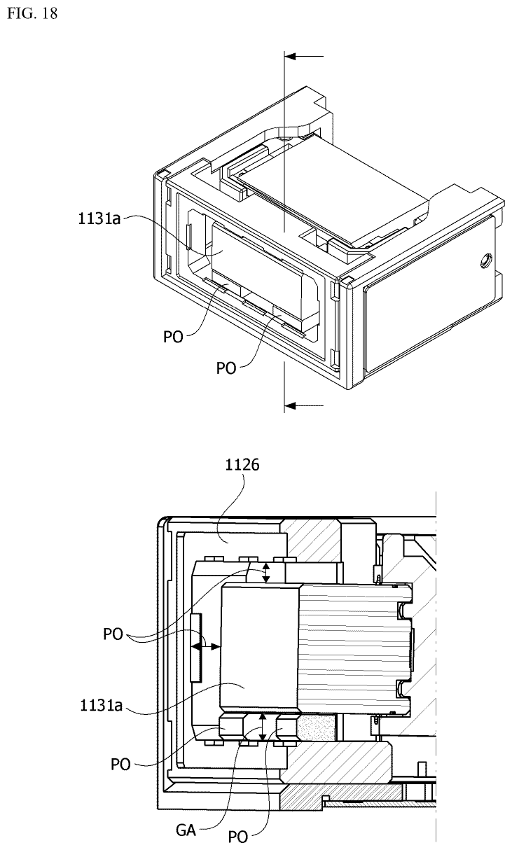

FIG. 17 is a cross-sectional view of a first camera actuator according to still another embodiment.

Referring to FIG. 17, the first camera actuator according to still another embodiment may include a housing, a mover, a rotating unit, a driving unit, a first member, a second member, a plate, and a shock absorption member. In the present embodiment, it should be understood that the description of the housing, the mover, the rotating unit, the driving unit, the first member, the second member, the plate, and the shock absorption member of the first camera actuator according to various embodiments, which will be described herein, may be applied in the same manner unless being contradictory.

In the present embodiment, a first separation distance may be greater than a second separation distance. Here, the first separation distance Lab is a distance between the first holder outer surface and the first housing side portion 1121 of the housing in the second direction. In addition, the second separation distance Laa may be a distance between the second holder outer surface and the second housing side portion 1122 of the housing in the second direction.

In addition, the optical member 1132 may be asymmetrical with respect to the third direction (the Z-axis direction), the optical axis, or the second line CL2. For example, both sides of the optical member 1132 may be asymmetrical in weight, shape, area, and volume with respect to the second line.

In addition, a separation distance Lbb between the optical member 1132 and the first housing side portion 1121 in the second direction may differ from a separation distance Lba between the optical member 1132 and the second housing side portion in the second direction.

The separation distance Lbb between the optical member 1132 and the first housing side portion 1121 in the second direction may be greater than the separation distance Lba between the optical member 1132 and the second housing side portion in the second direction.

That is, the optical member 1132 may have a greater area, volume, and the like of a region S2 adjacent to the first housing side portion 1121 than a region S1 adjacent to the second housing side portion 1122.

The region S2 is a region adjacent to the first housing side portion 1121 among the regions in which the optical member 1132 is bisected with respect to the second line CL2. In addition, the region S1 is a region adjacent to the second housing side portion 1122 among the regions in which the optical member 1132 is bisected with respect to the second line CL2.

With this configuration, the structural balance of the mover can be maintained by the asymmetrical structure of the optical member 1132. Furthermore, since the first magnet is disposed on only one side of the holder outer surface, the weight of the mover can be reduced, and the efficiency of the driving unit can also be increased.

FIG. 18 shows a perspective view and cross-sectional view of the first camera actuator according to the embodiment.

Referring to FIG. 18, the shock absorption member PO may be located between the second member 1131a and the first member 1126. As described above, the second member 1131a may pass through the first member 1126. However, a length of the second member 1131a in the first direction may be smaller than a length of the first member 1126 in the first direction. Furthermore, during an assembly process of inserting the second member 1131a from the side portion and allowing the second member 1131a to pass through the first member 1126, a separation space GA may exist between the second member 1131a and the first member 1126 in the first direction. The separation space GA may correspond to a separation space between the hole of the first member 1126 and the second member 1131a. The shock absorption member PO may be disposed in the separation space GA. For example, the shock absorption member PO may be located below the second member 1131a. Accordingly, the shock absorption member PO may have a reduced amount of shock of the second member 1131a with respect to the tilting of the second member 1131a and act as a stopper.

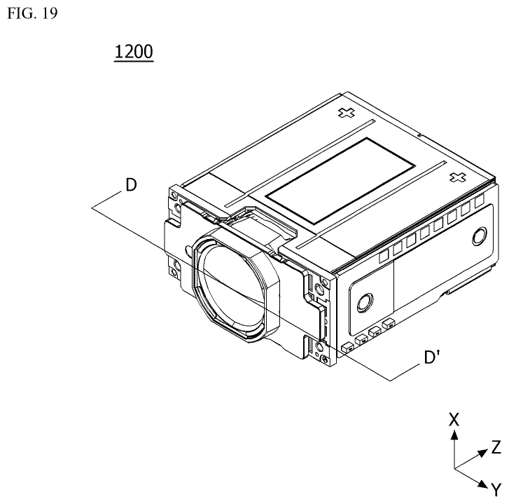

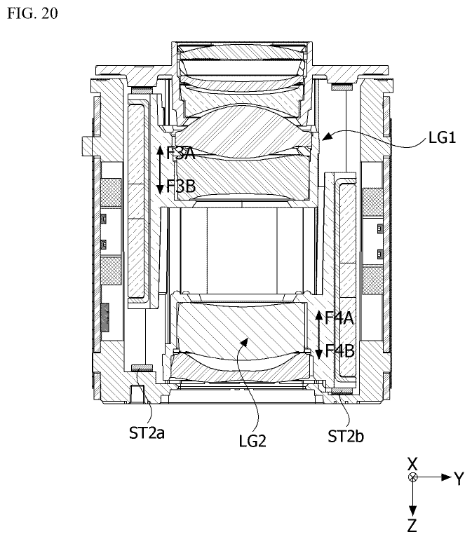

FIG. 19 is a perspective view of a second camera actuator according to the embodiment, and FIG. 20 is a view along line DD′ in FIG. 19.

Referring to FIGS. 19 and 20, the second camera actuator 1200 according to the embodiment may include the single lens or the plurality of lenses LG1 and LG2 as described above.

The second camera actuator may include a driving unit and move at least one of the plurality of lenses along the optical axis or the third direction (the Z-axis direction) by the driving unit. According to the driving forces F3A, F3B, F4A, and F4B generated by the driving unit, the lenses LG1 and LG2 may move individually or integrally. In an embodiment, each lens may move in the optical axis direction.

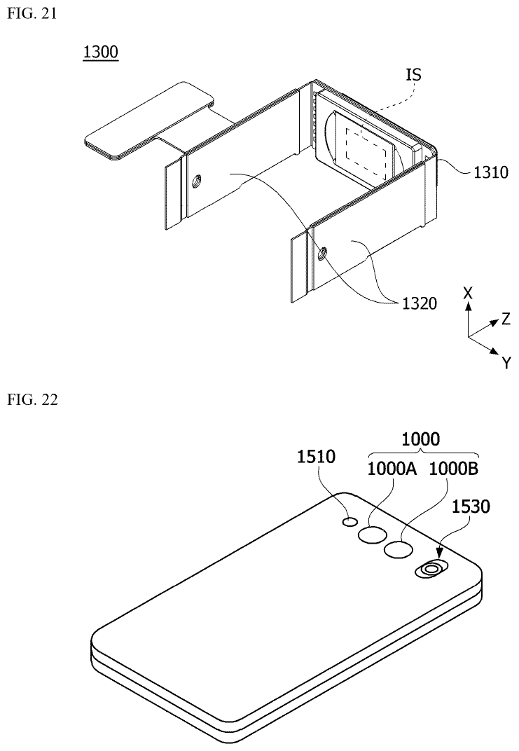

FIG. 21 is a schematic view illustrating a circuit board according to the embodiment.

Referring to FIG. 21, as described above, the circuit board 1300 according to the embodiment may include a first circuit board 1310 and a second circuit board 1320. The first circuit board 1310 may be located under the base and coupled to the base. In addition, the image sensor IS may be disposed on the first circuit board 1310. In addition, the first circuit board 1310 and the image sensor IS may be electrically connected. That is, the base may be located behind the second camera actuator, and the image sensor and the circuit board (first circuit board unit) may be located behind the base. The base may include a filter (e.g., infrared rays).

In addition, the second circuit board 1320 may be located on a side portion of the base. In particular, the second circuit board 1320 may be located on a first side portion of the base. Accordingly, the second circuit board 1320 may be located adjacent to the fourth coil located adjacent to the first side portion, thus an electrical connection can be easy. In addition, the second circuit board 1320 may be located on the second side portion. As described above, the second circuit board 1320 may be provided as a plurality of second circuit boards. However, the embodiments of the present invention are not limited thereto, and the second circuit board 1320 may be disposed on only one of the first side portion and the second side portion.

Furthermore, the circuit board 1300 may further include a fixed board (not illustrated) located on a side surface thereof. Accordingly, even when the circuit board 1300 is formed of a flexible material, the circuit board 1300 may be coupled to the base while maintaining stiffness by the fixed board.

The second circuit board 1320 of the circuit board 1300 may be located on the side portion of the driving unit of the second camera actuator. The circuit board 1300 may be electrically connected to the first driving unit of the first camera actuator and the second driving unit of the second camera actuator. For example, electrical connection may be made by a surface mounting technology (SMT). However, the embodiments of the present invention are not limited to such a method.

The circuit board 1300 may include a circuit board having line patterns that may be electrically connected, such as a rigid printed circuit board (PCB), a flexible PCB, a rigid-flexible PCB, etc. However, the embodiments of the present invention are not limited to these types.

In addition, the circuit board 1300 may be electrically connected to another camera module in the terminal or a processor of the terminal. Accordingly, the camera actuator and the camera device including the same may transmit and receive various signals in the terminal.

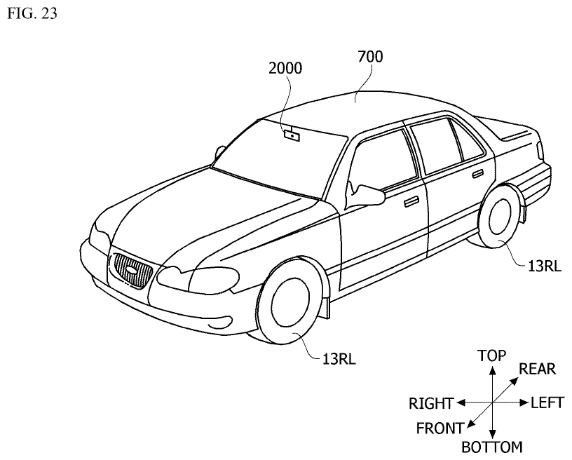

FIG. 22 is a perspective view of a mobile terminal to which the camera module according to the embodiment is applied.

As illustrated in FIG. 22, a mobile terminal 1500 of the embodiment may include a camera module 1000, a flash module 1530, and an AF device 1510, which are provided on a rear surface thereof.

The camera module 1000 may include an image capturing function and an AF function. For example, the camera module 1000 may include the AF function using an image.

The camera module 1000 processes an image frame of a still image or a moving image obtained by an image sensor in a capturing mode or a video call mode.

The processed image frame may be displayed on a predetermined display and stored in a memory. A camera (not illustrated) may also be disposed on a front surface of a body of the mobile terminal.

For example, the camera module 1000 may include a first camera module 1000A and a second camera module 1000B, and the first camera module 1000A may implement an OIS function along with an AF or zooming function.

The flash module 1530 may include a light-emitting element for emitting light therein. The flash module 1530 may be operated by a camera operation of the mobile terminal or a user's control.

The AF device 1510 may include one of a package of a surface light-emitting laser element as a light-emitting part.

The AF device 1510 may include the AF function using a laser. The AF device 1510 may be mainly used in a condition that the AF function using the image of the camera module 1000 is degraded, for example, a proximity of 10 m or less or dark environment.

The AF device 1510 may include a light-emitting part including a vertical cavity surface emitting laser (VCSEL) semiconductor device and a light-receiving part for converting light energy into electrical energy, such as a photodiode.

FIG. 23 is a perspective view of a vehicle to which the camera module according to the embodiment is applied.

For example, FIG. 23 is an external view of the vehicle including a vehicle driving assistance device to which the camera module 1000 according to the embodiment is applied.

Referring to FIG. 23, a vehicle 700 in the embodiment may include wheels 13FL and 13FR rotated by a power source and a predetermined sensor. The sensor may be a camera sensor 2000, but is not limited thereto.

The camera sensor 2000 may be a camera sensor to which the camera module 1000 according to the embodiment is applied. The vehicle 700 according to the embodiment may acquire image information through the camera sensor 2000 for capturing a forward image or a surrounding image, determine a situation in which a lane is not identified using the image information, and generate a virtual lane when the lane is not identified.

For example, the camera sensor 2000 may acquire a forward image by capturing a forward view of the vehicle 700, and a processor (not illustrated) may acquire image information by analyzing an object included in the forward image.

For example, when a lane, an nearby vehicle, a traveling obstacle, and objects, such as a median, a curb, or a tree corresponding to an indirect road mark, are captured in the image captured by the camera sensor 2000, the processor may detect the object and include the detected object in the image information. In this case, the processor may further supplement the image information by acquiring distance information to the object detected through the camera sensor 2000.

The image information may be information about the object captured in the image. The camera sensor 2000 may include an image sensor and an image processing module.

The camera sensor 2000 may process still images or moving images obtained by the image sensor (e.g., a complementary metal-oxide semiconductor (CMOS) or a charge-coupled device (CCD)).

The image processing module may process the still images or moving images acquired through the image sensor to extract necessary information and transmit the extracted information to the processor.

In this case, the camera sensor 2000 may include a stereo camera capable of improving the measurement accuracy of the object and further securing information such as a distance between the vehicle 700 and the object, but is not limited thereto.

Although embodiments have been mainly described above, these are only illustrative and do not limit the present invention, and those skilled in the art to which the present invention pertains can know that various modifications and applications that are not exemplified above are possible without departing from the essential characteristics of the embodiments. For example, each component specifically illustrated in the embodiments may be implemented by modification. In addition, differences related to these modifications and applications should be construed as being included in the scope of the present invention defined in the appended claims.

1.-10 (canceled)

11. A camera actuator comprising:
a housing;
a mover including a holder and an optical member disposed on the holder;
a driving unit that moves the mover; and
a tilting guide unit that is disposed between the housing and the mover and guides tilting of the mover,
wherein the mover is rotatable in at least one direction of a first direction and a second direction,
wherein the driving unit includes a first magnet and a second magnet disposed under the first magnet,
wherein the holder includes a first holder outer surface and a second holder outer surface that face each other in the second direction, and
wherein the first magnet is disposed on only one of the first holder outer surface and the second holder outer surface.

12. The camera actuator of claim 11, wherein the holder is asymmetrical with respect to a third direction perpendicular to the first direction and the second direction.

13. The camera actuator of claim 11, wherein the driving unit includes a first coil facing the first magnet and a second coil facing the second magnet, and
wherein the first coil is disposed on only a side portion of the housing which faces one of the first holder outer surface and the second holder outer surface.

14. The camera actuator of claim 12, wherein the driving unit includes a substrate unit connected to the first coil, and
wherein the substrate unit is disposed on a side portion of the housing which faces one of the first holder outer surface and the second holder outer surface.

15. The camera actuator of claim 14, wherein the substrate unit is asymmetrical with respect to the third direction perpendicular to the first direction and the second direction.

16. The camera actuator of claim 11, wherein the first magnet is disposed on the second holder outer surface.

17. The camera actuator of claim 16, wherein the first holder outer surface overlaps a hole of a first housing side portion of the housing, which faces the first holder outer surface, in a third direction.

18. The camera actuator of claim 16, wherein a first separation distance is greater than a second separation distance,
wherein the first separation distance is a distance between the first holder outer surface and a first housing side portion of the housing in the second direction, and
wherein the second separation distance is a distance between the second holder outer surface and a second housing side portion of the housing in the second direction.

19. The camera actuator of claim 16, wherein the optical member is asymmetrical with respect to a third direction perpendicular to the first direction and the second direction,

20. The camera actuator of claim 19, wherein a separation distance from a first housing side portion of the housing in the second direction differs from a separation distance from a second housing side portion of the housing in the second direction in the optical member.

21. The camera actuator of claim 11, wherein the optical member changes an optical path from the first direction to the third direction perpendicular to the first direction and the second direction.

22. The camera actuator of claim 11, further comprising a first magnet disposed in the housing.

23. The camera actuator of claim 22, further comprising a second magnet disposed to face the first magnet.

24. The camera actuator of claim 23, wherein the tilting guide unit is pressed by the mover by a repulsive force between the first magnet and the second magnet.

25. The camera actuator of claim 24, wherein the housing comprises a first member disposed on one side.

26. The camera actuator of claim 25, wherein the mover comprises a second member passing through the first member.

27. The camera actuator of claim 26, wherein the tilting guide unit is disposed between the first member and the mover.

28. The camera actuator of claim 27, wherein the first member includes a second groove located in an outer surface thereof,
wherein the second member includes a first groove facing the second groove,
wherein the first magnet is disposed in the second groove, and
wherein the second magnet is disposed in the first groove.

29. The camera actuator of claim 28, wherein the second magnet, the first magnet, and the tilting guide unit may be disposed sequentially in the second direction.

30. The camera actuator of claim 28, further comprising a shock absorption member disposed below the second member.
